(19) United States
(12) Patent Application Publication
(10) Pub. No.: US 2022/0256922 A1
(43) Pub. Date: Aug. 18, 2022

(54) VAPORIZER DEVICE

(71) Applicant: JUUL Labs, Inc., San Francisco, CA (US)

(72) Inventors: Ariel Atkins, San Francisco, CA (US); Mackenzie Paige Belt, San Francisco, CA (US); Christopher L. Belisle, Somerset, WI (US); Tsuey Choo Lily Chang, Lisle, IL (US); Brandon Cheung, San Francisco, CA (US); Steven Christensen, Burlingame, CA (US); Dylan E. Entelis, Los Angeles, CA (US); Nicholas J. Hatton, Oakland, CA (US); Alexander M. Hoopai, San Francisco, CA (US); Eric Joseph Johnson, San Francisco, CA (US); Jason King, San Francisco, CA (US); Esteban Leon Duque, Berkeley, CA (US); YongChao Li, Shanghai (CN); Huei-Huei Liang, Shanghai (CN); Kevin Lomeli, San Francisco, CA (US); Matthew J. Malone, Los Angeles, CA (US); James Monsees, San Francisco, CA (US); Nathan N. Ng, San Francisco, CA (US); Claire O'Malley, San Francisco, CA (US); Matthew Rios, San Francisco, CA (US); Christopher James Rosser, Cambridge (GB); Zachary T. Scott, Oakland, CA (US); Nihir B. Shah, San Francisco, CA (US); Andrew J. Stratton, Royston (GB); Alim Thawer, Cambridge (GB); Val Valentine, San Francisco, CA (US); Norbert Wesely, Cambridge (GB); James P. Westley, Cambridge (GB); Hao Yin, Shanghai (CN); XueHai Zhang, Shanghai (CN); XueQing Zhang, Shanghai (CN)

(21) Appl. No.: 17/736,008

(22) Filed: May 3, 2022

Related U.S. Application Data
(63) Continuation of application No. PCT/US20/58947, filed on Nov. 4, 2020.
Application No. PCT/US20/58947 is a continuation of application No. 16/805,672, filed on Feb. 28, 2020, now Pat. No. 11,253,001.
(60) Provisional application No. 63/108,874, filed on Nov. 3, 2020.
(60) Provisional application No. 62/981,498, filed on Feb. 25, 2020.
(60) Provisional application No. 62/947,496, filed on Dec. 12, 2019.
(60) Provisional application No. 62/930,508, filed on Nov. 4, 2019.

(51) Int. Cl. A24F 40/42; A24F 40/46; A24F 40/44; A24F 40/485; A24F 40/10

(52) U.S. Cl. CPC A24F 40/42; A24F 40/46; A24F 40/50; A24F 40/485; A24F 40/10; A24F 40/44

(57) ABSTRACT

A vaporizer device may include a shell, a cartridge receptacle, and a skeleton. The cartridge receptacle may be formed from a cartridge interface disposed at least partially inside a sheath. The cartridge interface may be configured to provide a plurality of electrical couplings with a vaporizer cartridge when the vaporizer cartridge is disposed inside the cartridge receptacle. The plurality of electrical couplings may include a first electrical coupling with a heating element of the vaporizer cartridge. The plurality of electrical couplings may further include a second electrical coupling with a cartridge identification chip of the vaporizer cartridge. The skeleton may be coupled with the cartridge interface. The skeleton may be configured to secure the cartridge interface inside the shell.

### CROSS REFERENCE TO RELATED APPLICATIONS

This application claims priority to U.S. Provisional Application No. 62/930,508, entitled “VAPORIZER DEVICE” and filed on Nov. 4, 2019, U.S. Provisional Application No. 62/947,496, entitled “VAPORIZER DEVICE” and filed on Dec. 12, 2019, U.S. Provisional Application No. 62/981,498, entitled “VAPORIZER DEVICE WITH VAPORIZER CARTRIDGE” and filed on Feb. 25, 2020, U.S. patent application Ser. No. 16/805,672, entitled “VAPORIZER DEVICE WITH VAPORIZER CARTRIDGE” and filed on Feb. 28, 2020, and U.S. Provisional Application No. 63/108,874, entitled “VAPORIZER DEVICE” and filed on Nov. 3, 2020. The disclosures of the foregoing applications are incorporated herein in their entirety, to the extent permissible.

### TECHNICAL FIELD

The subject matter described herein relates generally to vaporizer devices and more specifically to the design and construction of a vaporizer device.

### BACKGROUND

Vaporizer devices, which can also be referred to as vaporizers, electronic vaporizer devices or e-vaporizer devices, can be used for delivery of an aerosol (or “vapor”) containing one or more active ingredients by inhalation of the aerosol by a user of the vaporizing device. For example, electronic cigarettes, which may also be referred to as e-cigarettes, are a class of vaporizer devices that are typically battery powered and that may be used to simulate the experience of cigarette smoking, but without burning of tobacco or other substances.

In use of a vaporizer device, the user inhales an aerosol, commonly called vapor, which may be generated by a heating element that vaporizes (which generally refers to causing a liquid or solid to at least partially transition to the gas phase) a vaporizable material, which may be liquid, a solution, a solid, a wax, or any other form as may be compatible with use of a specific vaporizer device. The vaporizable material used with a vaporizer can be provided within a cartridge (e.g., a part of the vaporizer that contains the vaporizable material in a reservoir) that includes a mouthpiece (e.g., for inhalation by a user).

To receive the inhalable aerosol generated by a vaporizer device, a user may, in certain examples, activate the vaporizer device by taking a puff, by pressing a button, or by some other approach. A puff, as the term is generally used (and also used herein), refers to inhalation by the user in a manner that causes a volume of air to be drawn into the vaporizer device such that the inhalable aerosol is generated by a combination of vaporized vaporizable material with the air.

A typical approach by which a vaporizer device generates an inhalable aerosol from a vaporizable material involves heating the vaporizable material in a vaporization chamber (or a heater chamber) to cause the vaporizable material to be converted to the gas (or vapor) phase. A vaporization chamber generally refers to an area or volume in the vaporizer device within which a heat source (e.g., conductive, convective, and/or radiative) causes heating of a vaporizable material to produce a mixture of air and vaporized vaporizable material to form a vapor for inhalation by a user of the vaporization device.

In some vaporizer device embodiments, the vaporizable material can be drawn out of a reservoir and into the vaporization chamber via a wicking element (a wick). Such drawing of the vaporizable material into the vaporization chamber can be due, at least in part, to capillary action provided by the wick, which pulls the vaporizable material along the wick in the direction of the vaporization chamber. However, as vaporizable material is drawn out of the reservoir, the pressure inside the reservoir is reduced, thereby creating a vacuum and acting against the capillary action. This can reduce the effectiveness of the wick to draw the vaporizable material into the vaporization chamber, thereby reducing the effectiveness of the vaporization device to vaporize a desired amount of vaporizable material, such as when a user takes a puff on the vaporizer device. Furthermore, the vacuum created in the reservoir can ultimately result in the inability to draw all of the vaporizable material into the vaporization chamber, thereby wasting vaporizable material. As such, improved vaporization devices and/or vaporization cartridges that improve upon or overcome these issues is desired.

The term vaporizer device, as used herein consistent with the current subject matter, generally refers to portable, self-contained, devices that are convenient for personal use. Typically, such devices are controlled by one or more switches, buttons, touch sensitive devices, or other user input functionality or the like (which can be referred to generally as controls) on the vaporizer, although a number of devices that may wirelessly communicate with an external controller (e.g., a smartphone, a smart watch, other wearable electronic devices, etc.) have recently become available. Control, in this context, refers generally to an ability to influence one or more of a variety of operating parameters, which may include without limitation any of causing the heater to be turned on and/or off, adjusting a minimum and/or maximum temperature to which the heater is heated during operation, other interactive features that a user might access on a device, and/or other operations.

Various vaporizable materials having a variety of contents and proportions of such contents can be contained in the cartridge. Some vaporizable materials, for example, may have a smaller percentage of active ingredients per total volume of vaporizable material, such as due to regulations requiring certain active ingredient percentages. As such, a user may need to vaporize a large amount of vaporizable material (e.g., compared to the overall volume of vaporizable material that can be stored in a cartridge) to achieve a desired effect.

### SUMMARY

In certain aspects of the current subject matter, challenges associated with the design and construction of an electronic vaporizer device, particularly one configured to minimize the presence of liquid vaporizable materials in or near certain susceptible components, may be addressed by inclusion of one or more of the features described herein or comparable/equivalent approaches as would be understood by one of ordinary skill in the art.

In one aspect, there is provided a vaporizer device including a shell, a cartridge receptacle, and a skeleton. The cartridge receptacle may be formed from a cartridge interface disposed at least partially inside a sheath. The cartridge interface may be configured to provide a plurality of electrical couplings with a vaporizer cartridge when the vaporizer cartridge is disposed at least partially inside the cartridge receptacle. The plurality of electrical couplings may include a first electrical coupling with a heating element of the vaporizer cartridge. The plurality of electrical couplings may further include a second electrical coupling with a cartridge identification chip of the vaporizer cartridge. The skeleton may be coupled with the cartridge interface and configured to secure the cartridge interface inside the shell.

In some variations, one or more of the features disclosed herein including the following features can optionally be included in any feasible combination. The vaporizer device may further include a battery and a printed circuit board assembly including a controller of the vaporizer device. The printed circuit board assembly may be coupled to the battery and the cartridge interface to form a first assembly. The first assembly may be coupled to the skeleton to form a second assembly that is disposed inside the shell.

In some variations, the second assembly may further include an antenna.

In some variations, the shell may be formed from a first material. The vaporizer device may further include an endcap formed from a second material that is more penetrable to radio waves from the antenna than the first material. The endcap may be configured to seal an open end of the shell opposite to the cartridge receptacle.

In some variations, the shell may include one or more insets formed from the second material and/or a third material that are more penetrable to radio waves from the antenna than the first material.

In some variations, the cartridge interface may include a set of receptacle contacts configured to form the first electrical coupling with a set of heater contacts of the heating element of the vaporizer cartridge.

In some variations, the set of receptacle contacts may include two pairs of electrical contacts disposed at opposite sides of the cartridge receptacle.

In some variations, the cartridge interface may further include a set of cartridge identifier contacts configured to form the second electrical coupling with a corresponding set of cartridge identifier contacts at the cartridge identification chip of the vaporizer device.

In some variations, the set of cartridge identifier contacts may include a first set of three electrical contacts disposed at one side of the cartridge receptacle and a second set of three electrical contacts disposed at an opposite side of the cartridge receptacle.

In some variations, the set of cartridge identifier contacts may include at least one electrical contact that is preloaded to exert a force against a corresponding electrical contact at the cartridge identification chip.

In some variations, the sheath may be configured to prevent an overextension of the at least one electrical contact. The sheath may be further configured to prevent contact between the at least one electrical contact and the shell of the vaporizer device.

In some variations, the cartridge receptacle may be configured to receive the vaporizer cartridge in a first rotational orientation and a second rotational orientation. The cartridge interface may be configured to provide the plurality of electrical couplings with the vaporizer cartridge whether the vaporizer cartridge is inserted the first rotational orientation or the second rotational orientation.

In some variations, the sheath and the shell may be formed as a solitary unit.

In some variations, the sheath may be coupled to the shell by one or more of an adhesive, a friction fit, and/or a welding.

In some variations, the cartridge interface may be further configured to form, with the vaporizer cartridge, a mechanical coupling configured to retain the vaporizer cartridge inside the cartridge receptacle.

In some variations, the vaporizer device may further include a first retention feature configured to couple the vaporizer device to a charger device. The first retention feature may be configured to form a magnetic coupling with a second retention feature at the charger device. The magnetic coupling may align and maintain the vaporizer device in one or more position and/or orientation relative to the charger device.

In some variations, the first retention feature and the second retention feature may each comprise one or more magnets.

In some variations, one of the first retention feature and the second retention feature may include one or more magnets. The other one of the first retention feature and the second retention feature may include one or more blocks of ferrous metal.

In some variations, the skeleton may include one or more detents for securing, to an interior of the shell, the skeleton coupled with the cartridge interface.

In some variations, the cartridge receptacle may be configured to receive at least a portion of a wick housing containing a wicking element of the vaporizer cartridge. The first electrical coupling may be formed by at least contacting a contact portion of the heating element disposed at least partially outside of the wick housing while a heating portion of the heating element is disposed at least partially inside the wick housing.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 depicts a block diagram illustrating an example of a vaporizer device consistent with implementations of the current subject matter;

FIG. 2A depicts a planar cross-sectional view of an example of a vaporizer cartridge having a storage chamber and an overflow volume consistent with implementations of the current subject matter;

FIG. 2B depicts a planar cross-sectional view of an example of a vaporizer cartridge having a storage chamber and an overflow volume consistent with implementations of the current subject matter;

FIG. 2C depicts a planar cross-sectional view of an example of a vaporizer cartridge having a storage chamber and an overflow volume consistent with implementations of the current subject matter;

FIG. 2D depicts a planar cross-sectional view of an example of a vaporizer cartridge having a storage chamber and an overflow volume consistent with implementations of the current subject matter;

FIG. 2E depicts a planar cross-sectional view of an example of a vaporizer cartridge having a storage chamber and an overflow volume consistent with implementations of the current subject matter;

FIG. 2F depicts a planar cross-sectional view of a collector having an example of a microfluidic feature consistent with implementations of the current subject matter;

FIG. 2G depicts an exploded view of an example of a vaporizer cartridge consistent with implementations of the current subject matter;

FIG. 3A depicts a perspective view of a vaporizer cartridge having one example of a connector consistent with implementations of the current subject matter;

FIG. 3B depicts a perspective view of a vaporizer cartridge having another example of a connector consistent with implementations of the current subject matter;

FIG. 3C depicts a planar cross-sectional view of a vaporizer cartridge having one example of a connector consistent with implementations of the current subject matter;

FIG. 3D depicts a planar cross-sectional view of a vaporizer cartridge having another example of a connector of consistent with implementations of the current subject matter;

FIG. 4 depicts an exploded view of an example of the vaporizer body 110 consistent with implementations of the current subject matter;

FIG. 5A depicts an example of a pod identifier contact consistent with implementations of the current subject matter;

FIG. 5B depicts another example of a pod identifier contact consistent with implementations of the current subject matter;

FIG. 5C depicts another example of a pod identifier contact consistent with implementations of the current subject matter;

FIG. 5D depicts a perspective view of an example of a cartridge receptacle of a vaporizer body consistent with implementations of the current subject matter;

FIG. 5E depicts a perspective view of an example of a cartridge receptacle of a vaporizer body consistent with implementations of the current subject matter;

FIG. 6A depicts a side cut-out view of an example of a vaporizer cartridge disposed within a cartridge receptacle consistent with implementations of the current subject matter;

FIG. 6B depicts another side cut-out view of an example of a vaporizer cartridge disposed within a cartridge receptacle consistent with implementations of the current subject matter;

FIG. 7A depicts a perspective view of an example of a vaporizer body shell consistent with implementations of the current subject matter;

FIG. 7B depicts a cross-sectional view of an example of a vaporizer body shell consistent with implementations of the current subject matter;

FIG. 8A depicts an example of a retention feature consistent with implementations of the current subject matter;

FIG. 8B depicts another example of a retention feature consistent with implementations of the current subject matter;

FIG. 8C depicts another example of a retention feature consistent with implementations of the current subject matter;

FIG. 8D depicts various examples of a retention feature configured to enable face charging of a vaporizer device consistent with implementations of the current subject matter;

FIG. 8E depicts various examples of a retention feature configured to enable side charging of a vaporizer device consistent with implementations of the current subject matter;

FIG. 8F depicts various examples of magnet-to-magnet retention features consistent with implementations of the current subject matter;

FIG. 8G depicts various examples of magnet-to-metal retention features consistent with implementations of the current subject matter;

FIG. 9A depicts a flowchart illustrating an example of a process for assembling a vaporizer body consistent with implementations of the current subject matter;

FIG. 9B depicts a flowchart illustrating another example of a process for assembling a vaporizer body consistent with implementations of the current subject matter;

FIG. 9C depicts a flowchart illustrating another example of a process for assembling a vaporizer body consistent with implementations of the current subject matter;

FIG. 9D depicts a flowchart illustrating another example of a process for assembling a vaporizer body consistent with implementations of the current subject matter;

FIG. 9E depicts a flowchart illustrating another example of a process for assembling a vaporizer body consistent with implementations of the current subject matter; and

FIG. 9F depicts a flowchart illustrating another example of a process for assembling a vaporizer body consistent with implementations of the current subject matter.

When practical, similar reference numbers denote similar structures, features, or elements.

### DETAILED DESCRIPTION

Implementations of the current subject matter include devices relating to vaporizing of one or more vaporizable materials for inhalation by a user. Examples of vaporizer devices consistent with implementations of the current subject matter include electronic vaporizers, electronic cigarettes, e-cigarettes, or the like. The vaporizable material used with a vaporizer may optionally be provided within a cartridge (e.g., a part of the vaporizer that contains the vaporizable material in a reservoir or other container and that can be refillable when empty or disposable in favor of a new cartridge containing additional vaporizable material of a same or different type). A vaporizer device may be a cartridge-using vaporizer device, a cartridge-less vaporizer device, or a multi-use vaporizer device capable of use with or without a cartridge. For example, a multi-use vaporizer may include a heating chamber (e.g., an oven) configured to receive a vaporizable material directly in the heating chamber and also to receive a cartridge or other replaceable device having a reservoir, a volume, or the like for at least partially containing a usable amount of vaporizable material.

In various implementations, a vaporizer device may be configured for use with liquid vaporizable material (e.g., a carrier solution in which an active and/or inactive ingredient(s) are suspended or held in solution or a neat liquid form of the vaporizable material itself) or a solid vaporizable material. A solid vaporizable material may include a plant material that emits some part of the plant material as the vaporizable material (e.g., such that some part of the plant material remains as waste after the vaporizable material is emitted for inhalation by a user) or optionally can be a solid form of the vaporizable material itself (e.g., a “wax”) such that all of the solid material can eventually be vaporized for inhalation. A liquid vaporizable material can likewise be capable of being completely vaporized or can include some part of the liquid material that remains after all of the material suitable for inhalation has been consumed.

Implementations of the current subject matter may include a vaporizer device configured to couple with a vaporizer cartridge with various features to prevent liquid vaporizable material from leaking out of the vaporizer cartridge and/or other part of the vaporizer device. The design and construction of the various examples of vaporizer devices described herein may include one or more features for achieving optimal performance, for example, when the body of the vaporizer device is coupled with a vaporizer cartridge. Moreover, the design and construction of the various examples of vaporizer devices described herein may include one or more features for improving efficiency and consistency in manufacturing.

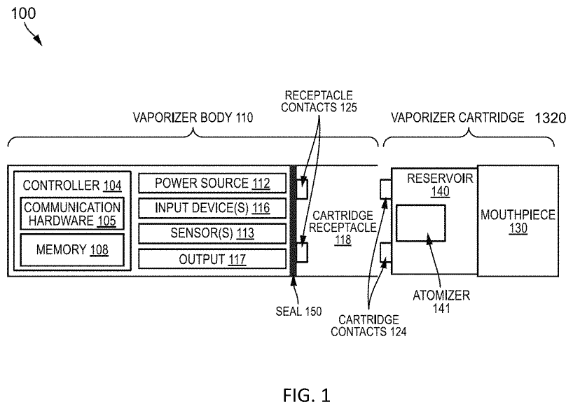

FIG. 1 depicts a block diagram illustrating an example of a vaporizer device 100 consistent with implementations of the current subject matter. Referring to FIG. 1, the vaporizer device 100 may include a power source 112 (e.g., a non-rechargeable primary battery, a rechargeable secondary battery, a fuel cell, and/or the like) and a controller 104 (e.g., a processor, circuitry, etc. capable of executing logic). The controller 104 may be configured to control the delivery of heat to an atomizer 141 to cause at least a portion of a vaporizable material 1302 included in the reservoir 140 to be converted from a condensed form (e.g., a solid, a liquid, a solution, a suspension, a part of an at least partially unprocessed plant material, etc.) to a gas phase. For example, the controller 104 may control the delivery of heat to the atomizer 141 by at least controlling a discharge of current from the power source 112 to the atomizer 141. The controller 104 may be part of one or more printed circuit boards (PCBs) consistent with certain implementations of the current subject matter.

After conversion of the vaporizable material 1302 to the gas phase, and depending on the type of vaporizer, the physical and chemical properties of the vaporizable material 1302, and/or other factors, at least some of the gas-phase vaporizable material 1302 may condense to form particulate matter in at least a partial local equilibrium with the gas phase as part of an aerosol. The vaporizable material 1302 in the condensed phase (e.g., the particulate matter) in at least partial local equilibrium with the vaporizable material 1302 in the gas phase may form some or all of an inhalable dose provided by the vaporizer device 100 for a given puff or draw on the vaporizer device 100. It will be understood that the interplay between the vaporizable material 1302 in the gas phase and in the condensed phase in an aerosol generated by the vaporizer device 100 can be complex and dynamic, as factors such as ambient temperature, relative humidity, chemistry, flow conditions in airflow paths (both inside the vaporizer and in the airways of a human or other animal), mixing of the gas-phase or aerosol-phase vaporizable material 1302 with other air streams, etc. may affect one or more physical parameters of an aerosol. In instances where the vaporizable material 1302 is volatile, the inhalable dose may exist predominantly in the gas phase (i.e., formation of condensed phase particles may be very limited).

To enable the vaporizer device 100 to be used with liquid formulations of the vaporizable material 1302 (e.g., neat liquids, suspensions, solutions, mixtures, etc.), the atomizer 141 may include a heating element 1350 as well as a wicking element 1362 (also referred to herein as a wick) formed from one or more materials capable of causing fluid motion by capillary pressure. The wicking element 1362 may convey a quantity of the liquid vaporizable material 1302 to a part of the atomizer 141 that includes the heating element 1350. The wicking element 1362 is generally configured to draw the liquid vaporizable material 1302 from the reservoir 140 containing the liquid vaporizable material 1302 such that the liquid vaporizable material 1302 may be vaporized by heat generated by the heating element 1350. Air may enter the reservoir 140 to replace the volume of liquid vaporizable material 1302 drawn out of the reservoir 140, for example, by the wicking element 1362. In other words, capillary action may pull liquid vaporizable material 1302 into the wicking element 1362 for vaporization by heat generated by the heating element 1350, and air may, in some implementations of the current subject matter, return to the reservoir 140 to at least partially equalize pressure in the reservoir 140. Various approaches for allowing air to enter the reservoir 140 to equalize pressure are within the scope of the current subject matter as discussed in greater detail below.

The heating element 1350 can be or include one or more of a conductive heater, a radiative heater, and a convective heater. One example of the heating element 1350 is a resistive heating element, which can be constructed of or at least include a material (e.g., a metal or alloy, for example a nickel-chromium alloy, or a non-metallic resistor) configured to dissipate electrical power in the form of heat when electrical current is passed through one or more resistive segments of the heating element 1350. In some implementations of the current subject matter, the heating element 1350 can configured to deliver heat to the wicking element 1362, for example, by being wrapped at least partially around, positioned at least partially within, at least partially integrated into a bulk shape of, and/or positioned in at least partial thermal contact with the wicking element 1362. Heat delivered to the wicking element 1362 may cause at least a portion of the liquid vaporizable material 1302 drawn into the wicking element 1362 from the reservoir 140 to be vaporized for subsequent inhalation by a user in a gas phase and/or a condensed (e.g., aerosol particles or droplets) phase. As discussed further below, the wicking element 1362 and the heating element 1350 may be configured in various manners in order to form the atomizer 141.

Alternatively and/or additionally, the vaporizer device 100 may also be configured to heat a non-liquid formulation of the vaporizable material 1302 to generate an inhalable dose of the vaporizable material 1302 in a gas-phase and/or an aerosol-phase. Examples of non-liquid formulations of the vaporizable material 1302 include a solid-phase vaporizable material (e.g., a wax or the like) or a plant material (e.g., tobacco leaves and/or parts of tobacco leaves). Accordingly, the heating element 1350 may be part of or otherwise incorporated into or in thermal contact with the walls of a heating chamber (e.g., an oven and/or the like) into which the non-liquid vaporizable material 1302 is placed. Alternatively, the heating element 1350 may be used to heat air passing through or past the non-liquid vaporizable material 1302 to cause convective heating of the non-liquid vaporizable material 1302. In still other examples, the heating element 1350 may be a resistive heating element disposed in intimate contact with non-liquid vaporizable material 1302 such that direct conductive heating of the non-liquid vaporizable material 1302 occurs from within a mass of the non-liquid vaporizable material 1302 (e.g., as opposed to by conduction inward from the walls of a heating chamber).

To vaporize the vaporizable material 1302, the vaporizer device 100 may deliver, to the heating element 1350, electrical power from the power source 112 (e.g., a battery and/or the like). The delivery of electrical power to the heating element 1350 may be controlled by the controller 104. For example, electrical power may be delivered to the heating element 1350 by discharging a current from the power source 112 through a circuit including the heating element 1350. The controller 104 may activate the heating element 1350, for example, by causing the power source 112 to deliver electrical power (e.g., discharge current) to the heating element 1350, in response to a user puffing (e.g., drawing, inhaling, and/or the like) on a mouthpiece 1330 of the vaporizer device 100. The user puffing on the mouthpiece of the vaporizer device 100 may cause air to flow from an air inlet, along an airflow path that traverses the atomizer 141 including the heating element 1350 and the wicking element 1362, and optionally through one or more condensation areas or chambers, to an air outlet in the mouthpiece 1330. Incoming air passing along the airflow path may pass over or through the atomizer 141, where the vaporizable material 1302 in the gas phase may be entrained into the air. As noted above, the entrained gas-phase vaporizable material 1302 may condense as it passes through the remainder of the airflow path such that an inhalable dose of the vaporizable material 1302 in an aerosol form can be delivered from the air outlet disposed in the mouthpiece 1330 for inhalation by a user.

The heating element 1350 can be activated in response to a user puffing (i.e., drawing, inhaling, etc.) on a mouthpiece 1330 of the vaporizer device 100 to cause air to flow from an air inlet, along an airflow path that passes the atomizer 141 including the wicking element 1362 and the heating element 1350. Optionally, air can flow from an air inlet through one or more condensation areas or chambers, to an air outlet in the mouthpiece 1330. Incoming air moving along the airflow path moves over or through the atomizer 141, where the vaporizable material 1302 in the gas phase is entrained into the air. The heating element 1350 can be activated via the controller 104, which can optionally be a part of a vaporizer body 110 as discussed herein, causing current to pass from the power source 112 through a circuit including the heating element 1350. Although shown as a part of a vaporizer cartridge 1320, it should be appreciated that the at least a portion of the atomizer 141 including the heating element 1350 may also be disposed in the vaporizer body 110. As noted herein, the entrained vaporizable material 1302 in the gas phase can condense as it passes through the remainder of the airflow path such that an inhalable dose of the vaporizable material 1302 in an aerosol form can be delivered from the air outlet (for example, the mouthpiece 1330) for inhalation by a user.

The heating element 1350 may be activated by the controller 104 in response to the controller detecting an occurrence (or an imminent occurrence) of a puff based on one or more signals received from the sensors 113. The sensors 113 can include one or more of a pressure sensor configured to detect pressure along the airflow path and/or an ambient pressure, a motion sensor (e.g., an accelerometer) configured to detect a movement of the vaporizer device 100, a flow sensor, a capacitive sensor configured to detect interaction between a user and the vaporizer device 100, and/or the like. Alternatively and/or additionally, the occurrence of a puff and/or the imminent occurrence of a puff may be detected based on a user interaction with one or more input devices 116 (e.g., buttons or other tactile control devices of the vaporizer device 100), one or more signals from a computing device in communication with the vaporizer device 100, and/or the like.

In some implementations of the current subject matter, the vaporizer device 100 may be configured to connect (e.g., wirelessly or via a wired connection) to a computing device (or optionally two or more devices) in communication with the vaporizer. To this end, the controller 104 may include communication hardware 105. The controller 104 may also include a memory 108. A computing device can be a component of a vaporizer system that also includes the vaporizer device 100, and can include its own communication hardware, which can establish a wireless communication channel with the communication hardware 105 of the vaporizer device 100. For example, a computing device used as part of a vaporizer system may include a general purpose computing device (e.g., a smartphone, a tablet, a personal computer, some other portable device such as a smartwatch, or the like) that executes software to produce a user interface for enabling a user of the device to interact with a vaporizer. In other implementations of the current subject matter, such a device used as part of a vaporizer system can be a dedicated piece of hardware such as a remote control or other wireless or wired device having one or more physical or soft (e.g., configurable on a screen or other display device and selectable via user interaction with a touch-sensitive screen or some other input device like a mouse, pointer, trackball, cursor buttons, or the like) interface controls. As shown in FIG. 1, the vaporizer device 100 can also include one or more output 117 features or devices for providing information to the user.

In the example in which a computing device provides signals related to activation of the heating element 1350, or in other examples of coupling of a computing device with the vaporizer device 100 for implementation of various control or other functions, the computing device may execute one or more computer instructions sets to provide a user interface and underlying data handling. In one example, detection by the computing device of user interaction with one or more user interface elements can cause the computing device to signal the vaporizer device 100 to activate the heating element 1350, either to a full operating temperature for creation of an inhalable dose of vapor/aerosol. Other functions of the vaporizer may be controlled by interaction of a user with a user interface on a computing device in communication with the vaporizer device 100.

The temperature of the heating element 1350 of the vaporizer device may depend on a number of factors, including an output voltage of the power source 112, a duty cycle at which the electrical power is delivered, conductive heat transfer to other parts of the electronic vaporizer and/or to the environment, latent heat losses due to vaporization of the vaporizable material 1302 from the wicking element 1362 and/or the atomizer 141 as a whole, and convective heat losses due to airflow (e.g., air moving across the heating element 1350 or the atomizer 141 as a whole when a user inhales on the electronic vaporizer). As noted above, to reliably activate the heating element 1350 or heat the heating element 1350 to a desired temperature, the controller 104 may use signals from the one or more sensors 113 that indicate a pressure in the airflow path, an ambient pressure, and/or the like. In order to determine the pressure in the airflow path, the one or more sensors 113 may include at least one pressure sensor disposed along in the airflow path. Alternatively and/or additionally, the at least one pressure sensor may also be connected (e.g., by a passageway or other path) to the airflow path connecting an inlet for air to enter the vaporizer device 100 and an outlet via which the user inhales the resulting vapor and/or aerosol such that the pressure sensor is able to detect pressure changes concurrently with air passing through the vaporizer device 100 from the air inlet to the air outlet. In some implementations of the current subject matter, the controller 104 may activate the heating element 1350 in response to one or more signals from the pressure sensor indicating a pressure change in the airflow path and/or a greater than threshold difference between a pressure in the airflow path and an ambient pressure.

Typically, the sensors 113 (e.g., the pressure sensor, the motion sensor, the capacitive sensor, and/or the like) be positioned on or coupled (e.g., electrically or electronically connected, either physically or via a wireless connection) to the controller 104 (e.g., a printed circuit board assembly or other type of circuit board). To take measurements accurately and maintain durability of the vaporizer device 100, a resilient seal 150 may optionally separate an airflow path from other parts of the vaporizer device 100. The seal 150, which can be a gasket, may be configured to at least partially surround the pressure sensor such that connections of the pressure sensor to internal circuitry of the vaporizer device 100 are separated from a part of the pressure sensor exposed to the airflow path. In instances where the vaporizer device 100 is configured to couple to a vaporizer cartridge 1320, the seal 150 may also separate parts of one or more electrical connections between a vaporizer body 110 and the vaporizer cartridge 1320 from one or more other parts of the vaporizer body 110. Such arrangements of the seal 150 in the vaporizer device 100 can be helpful in mitigating against potentially disruptive impacts on vaporizer components resulting from interactions with environmental factors such as water in the vapor or liquid phases, other fluids such as the vaporizable material 1302, etc. and/or to reduce escape of air from the designed airflow path in the vaporizer device 100. Unwanted air, liquid or other fluid passing and/or contacting circuitry of the vaporizer device 100 can cause various unwanted effects, such as alter pressure readings, and/or can result in the buildup of unwanted material, such as moisture, the vaporizable material 1302, etc. in parts of the vaporizer where they may result in poor pressure signal, degradation of the pressure sensor or other components, and/or a shorter life of the vaporizer device 100. Leaks in the seal 150 can also result in a user inhaling air that has passed over parts of the vaporizer device 100 containing or constructed of materials that may not be desirable to be inhaled.

The vaporizer device 100 may be, as noted, a cartridge-based vaporizer configured to couple with, for example, the vaporizer cartridge 1320. Accordingly, in addition to the controller 104, the power source 112 (e.g., battery), the one more sensors 113, one or more charging contacts 124, and the seal 150, FIG. 1 show the vaporizer body 110 of the vaporizer device 100 as including a cartridge receptacle 118 configured to receive at least part of the vaporizer cartridge 1320 for coupling with the vaporizer body 110 through one or more of a variety of attachment structures. As noted, the vaporizer cartridge 1320 may include the reservoir 140 for containing the vaporizable material 1302 and the mouthpiece 1330 for delivering an inhalable dose to a user. The atomizer 141 including, for example, the wicking element 1362 and the heating element 1350, may be disposed at least partially within the vaporizer cartridge 1320. Optionally, the heating element 1350 and/or the wicking element 1362 can be disposed within the vaporizer cartridge 1320 such that walls enclosing the cartridge receptacle 118 surround all or at least part of the heating element 1350 and/or the wicking element 1362 when the vaporizer cartridge 1320 is fully connected to the vaporizer body 110.

In some implementations of the current subject matter, the portion of the vaporizer cartridge 1320 that inserts into the cartridge receptacle 118 of the vaporizer body 110 may be positioned internal to another part of the vaporizer cartridge 1320. For example, the insertable part of the vaporizer cartridge 1320 may be at least partially surrounded by some other part, such as for example a housing and/or an outer shell, of the vaporizer cartridge 1320.

Alternatively, at least a portion of the atomizer 141 (e.g., one or both of the wicking element 1362 and the heating element 1350) may be disposed in the vaporizer body 110 of the vaporizer device 100. In implementations in which a portion of the atomizer 141 (e.g., the heating element 1350 and/or the wicking element 1362) is part of the vaporizer body 110, the vaporizer device 100 can be configured to deliver at least the vaporizer material 1302 from the reservoir 140 in the vaporizer cartridge 1320 to the portions of the atomizer 141 included in the vaporizer body 110.

As mentioned above, removal of the vaporizable material 1302 from the reservoir 140 (e.g., via capillary draw by the wicking element 1362) can create, in the reservoir 140, at least a partial vacuum (e.g., a reduced pressure created in a part of the reservoir 140 that has been emptied by consumption of the vaporizable material 1302) relative to ambient air pressure, and such a vacuum may interfere with the capillary action provided by the wicking element 1362. This reduced pressure may, in some examples, be sufficiently large in magnitude to reduce the effectiveness of the wicking element 1362 for drawing liquid vaporizable material 1302, thereby reducing the effectiveness of the vaporizer device 100 to vaporize a desired amount of vaporizable material 1302, such as when a user takes a puff on the vaporizer device 100. In extreme cases, the vacuum created in the reservoir 140 could result in the inability to draw all of the vaporizable material 1302 from the reservoir 140, thereby leading to incomplete usage and waste of the vaporizable material 1302. To prevent the formation of a vacuum, the reservoir 140 may include one or more venting features (regardless of positioning of the reservoir 140 in the vaporizer cartridge 1320 or elsewhere in the vaporizer device 100) to enable at least partial equalizing (optionally completely equalizing) of pressure in the reservoir 140 with ambient pressure (e.g., pressure in ambient air outside of the reservoir 140) to alleviate this issue.

In some cases, while allowing pressure equalization within the reservoir 140 improves efficiency of delivery of the liquid vaporizable material to the atomizer 141, it may do so by causing the otherwise empty void volume (e.g., space emptied by use of the liquid vaporizable material 1302) within the reservoir 140 to be filled with air. As discussed in further detail below, this air-filled void volume may subsequently experience pressure changes relative to ambient air. This pressure change may, under certain conditions, result in the vaporizable material 1302 leaking out of the reservoir 140 and ultimately out of the vaporizer cartridge 1320 and/or other part of the vaporizer device 100 including the reservoir 140. For example, a negative pressure event in which the pressure inside the vaporizer cartridge 1320 is sufficiently high to displace at least a portion of the vaporizable material 1302 in the reservoir 140 may be triggered by various environmental factors such as, for example, a change in ambient temperature, altitude, volume of the vaporizer cartridge 1320 (e.g., the reservoir 140), and/or the like. Implementations of the current subject matter may minimize and/or eliminate the leakage of the vaporizable material 1302 while still providing one or more mechanisms for preventing the formation of a vacuum (or partial vacuum) within the reservoir 140.

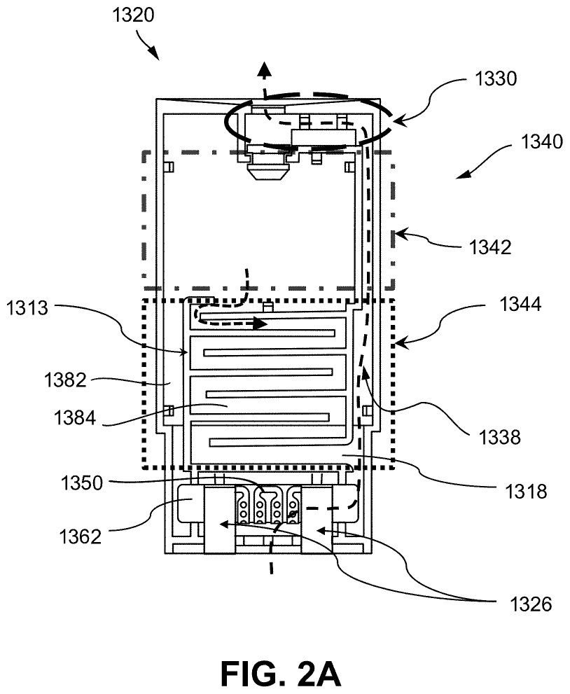

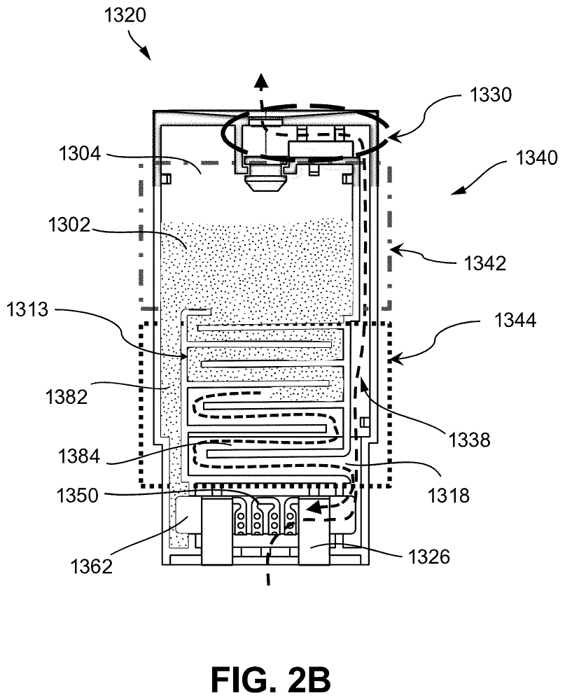

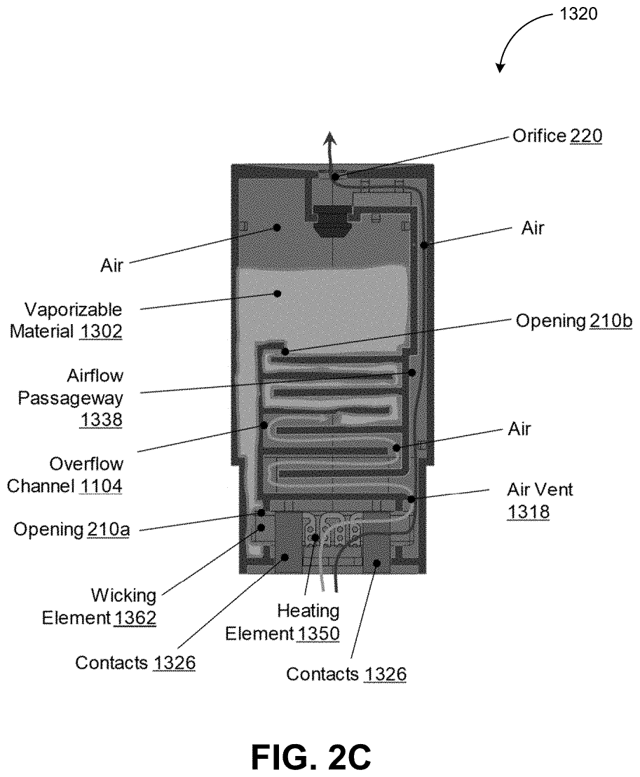

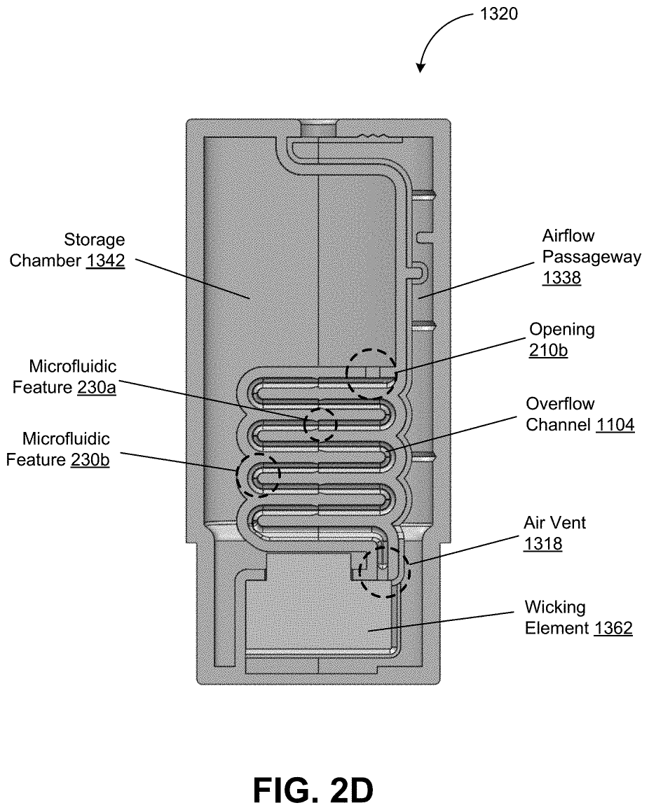

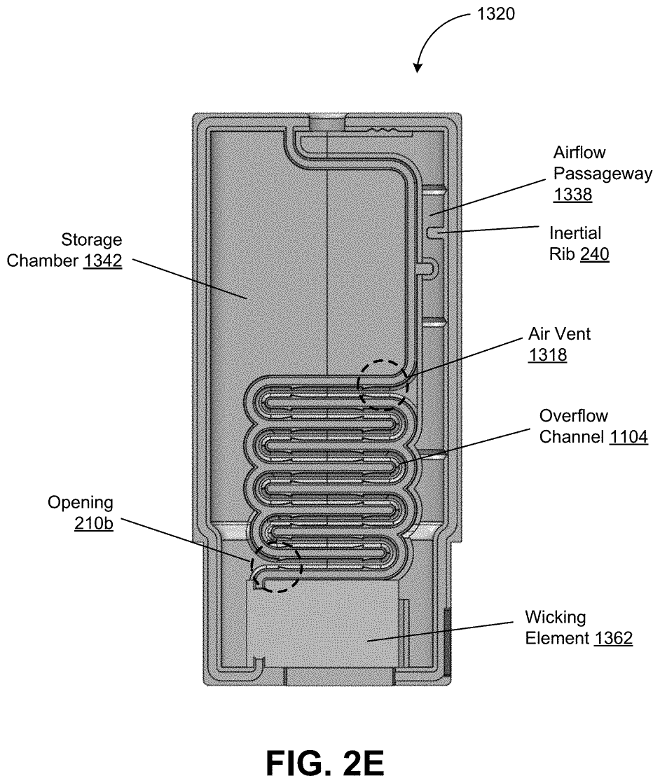

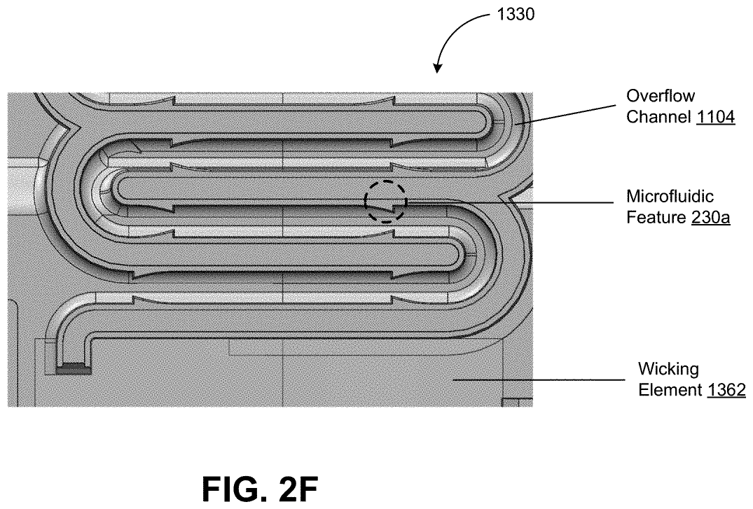

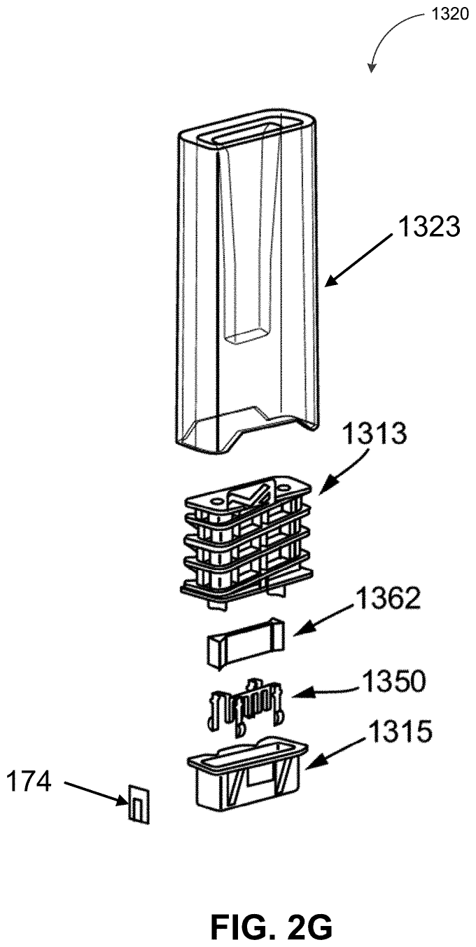

FIGS. 2A-C depict planar cross-sectional views of an example of the vaporizer cartridge 1320 consistent with implementations of the current subject matter. As shown in FIGS. 2A-C, the vaporizer cartridge 1320 may include the mouthpiece 1330, the reservoir 140 containing the vaporizable material 1302, and the atomizer 141. The atomizer 141 may, as noted, include the heating element 1350 and the wicking element 1362, together or separately, depending on implementation, such that the wicking element 1362 is thermally or thermodynamically coupled to the heating element 1350 for the purpose of vaporizing the vaporizable material 1302 drawn into or stored in the wicking element 1362.

FIG. 2G depicts an exploded view of an example of the vaporizer cartridge 1320 consistent with implementations of the current subject matter. As shown in FIG. 2G, the vaporizer cartridge 1320 may further include a wick housing 1315. The wicking element 1362 and the heating element 1350 may be disposed at least partially inside the wick housing 1315. For example, a heating portion of the heating element 1350, which may be in contact with the wicking element 1362, may be disposed at least partially inside the wick housing 1315 while a contact portion of the heating element (including the one or more contacts 1326) may extend at least partially outside of the wick housing 1315. An identification chip 174 may be coupled to an exterior wall of the wick housing 1315. Moreover, a housing 1323 of the vaporizer cartridge 1320 may be disposed over an assembly including the collector 1313 as well as the wick housing 1315 including the wicking element 1362, heating element 1350, and the identification chip 174. For example, the housing 1323 coupled with the collector 1313 may form at least a portion of the reservoir 140, in which the vaporizable material 1302 is contained within the storage chamber 1342 and/or the overflow channel 1104. The housing 1323 of the vaporizer cartridge 1320 may extend below an open top of the wick housing 1315 to create a space between an exterior wall of the wick housing 1315 and an interior wall of the housing 1323. When the vaporizer cartridge 1320 is coupled with the vaporizer body 110, the wall of the cartridge receptacle 118 may be disposed at least partially in the space that is formed between the exterior wall of the wick housing 1315 and the interior wall of the housing 1323.

The vaporizer cartridge 1320 may include one or more contacts 1326 configured to provide for an electrical connection between the heating element 1350 and a power source (e.g., the power source 112 shown in FIG. 1). For example, in some implementations of the current subject matter, the one or more contacts 1326 may be formed from a portion of the heating element 1350 that is folded such that the one or more contacts 1326 may be in electrical contact with the receptacle contacts 125 in the vaporizer body 110. The one or more contacts 1326 may also be configured to form a mechanical coupling with the cartridge receptacle 118. An airflow passageway 1338, defined through or on a side of the reservoir 140, may connect an area in the vaporizer cartridge 1320 that houses the wicking element 1362 (e.g., the wick housing 1315 and/or the like) to an orifice 220 in the mouthpiece 1330 to provide a route for the vaporized vaporizable material 1302 to travel from the heating element 1350 area and out of the orifice 220 in the mouthpiece 1330.

As provided above, the wicking element 1362 may be coupled to the heating element 1350 (e.g., a resistive heating element or coil) having and/or is coupled to the one or more contacts 1326. It should be appreciated that the heating element 1350 may have various shapes and/or configurations including, for example, one or more shapes and/or configurations in which the heating element 1350 is formed from a substrate material that has been shaped to include a heating portion in contact with the wicking element 1362 as well as a contact portion including the one or more contacts 1326.

In some implementations of the current subject matter, the heating element 1350 of the vaporizer cartridge 1320 may be formed from a sheet of substrate material that is either crimped around at least a portion of the wicking element 1362 or bent to provide the heating portion configured to receive the wicking element 1362. For example, the wicking element 1362 may be pushed into the heating element 1350. Alternatively and/or additionally, the heating element 1350, for example, the heating portion of the heating element 1350, may be held in tension and pulled over the wicking element 1362.

The heating element 1350 may be bent such that the heating element 1350 secures the wicking element 1362 between at least two or three portions of the heating element 1350. Moreover, the heating element 1350 may be bent to conform to a shape of at least a portion of the wicking element 1362. Configurations of the heating element 1350 may allow for more consistent and enhanced quality manufacturing of the heating element 1350. Consistency of manufacturing quality of the heating element 1350 may be especially important during scaled and/or automated manufacturing processes. For example, the heating element 1350 in accordance with one or more implementations may help to reduce tolerance issues that may arise during manufacturing processes when assembling a heating element 1350 having multiple components.

Additionally, discussed further below in regards to an included embodiment relating to a heating element formed of crimped metal, the heating element 1350 may be entirely and/or selectively plated with one or more materials to enhance heating performance of the heating element 1350. Plating all or a portion of the heating element 1350 including, for example, at least a portion of the contact portion of the heating element 1350 including the one or more contacts 1326, may help to minimize heat losses. Plating may also help in concentrating heat to at least a portion of the heating element 1350, thereby increasing the efficiency of heating the heating element 1350 including by reducing heat losses. It should be appreciated that selectively plating some but not all portions of the heating element 1350 may help to direct the current provided to the heating element 1350 to a proper location, for example, the contact portion of the heating element 1350 including the one or more contacts 1326. Selective plating may also help to reduce the amount of plating material and/or costs associated with manufacturing the heating element 1350.

As noted above, the heating element 1350, in some implementations of the current subject matter, may be configured to receive at least a portion of the wicking element 1362 such that the wicking element 1362 is disposed at least partially inside the heating element 1350 (e.g., a heating portion of the heating element 1350). For example, the wicking element 1362 may extend near or next to contacts 1326 and through the heating portion of the heating element 1350 in contact with plates 1326. The wick housing 1315 may surround at least a portion of the heating element 1350 and connect the heating element 1350 directly or indirectly to the airflow passageway 1338. The vaporizable material 1302 may be drawn by the wicking element 1362 through one or more passageways connected to the reservoir 140. For example, as shown in FIG. 2C, the reservoir 140 may include a first opening 210a that is in fluid communication with the wicking element 1362 such that the vaporizable material 1302 may be drawn by the wicking element 1362 through at least the first opening 210a. In one embodiment, one or both of the primary passageway 1382 or an overflow channel 1104 may be utilized to help route or deliver the vaporizable material 1302 to one or more portions of the wicking element 1362 (e.g., to one or both ends of the wicking element 1362, radially along a length of the wicking element 1362, and/or the like). Moreover, in some implementations of the current subject matter, an interior surface of the wick housing 1315 may include one or more fluidic features configured to route and/or deliver the vaporizable material 1302 to one or more portions of the wicking element 1362.

As provided in further detail below, particularly with reference to FIGS. 2A-B, exchange of air and the vaporizable material 1302 into and out of the reservoir 140 of the vaporizer cartridge 1320 may be advantageously controlled by incorporated a structure referred to as a collector 1313. The inclusion of the collector 1313 may also improve a volumetric efficiency of the vaporizer cartridge 1320, defined as a volume of liquid vaporizable material that is eventually converted to an inhalable aerosol relative to a total volume of the liquid vaporizable material included in the vaporizer cartridge 1320 (which may correspond to a capacity of the vaporizer cartridge 1320 itself).

In accordance with some implementations, the vaporizer cartridge 1320 may include the reservoir 140 that is at least partially defined by at least one wall (which can optionally be a wall that is shared with an outer shell of the cartridge) configured to contain a liquid vaporizable material 1302. The reservoir 140 may include a storage chamber 1342 and an overflow volume 1344, which may include or otherwise contain the collector 1313. The storage chamber 1342 may contain the vaporizable material 1302 and the overflow volume 1344 may be configured to collect and/or retain at least a portion of the vaporizable material 1302, when one or more factors cause the vaporizable material 1302 in the reservoir storage chamber 1342 to travel into the overflow volume 1344. In some implementations of the current subject matter, the vaporizer cartridge 1320 may be initially filled with the vaporizable material 1302 such that void space within the collector 1313 is pre-filled with the vaporizable material 1302.

In some implementations of the current subject matter, the volumetric size of the overflow volume 1344 may be configured to be equal to, approximately equal to, or greater than the amount of increase in the volume of the content (e.g., vaporizable material 1302 and air) contained in the storage chamber 1342, when the volume of the content in the storage chamber 1342 expands due to a maximum expected change in pressure that the reservoir 140 may undergo relative to an ambient pressure.

Depending on changes in ambient pressure, temperature, and/or other factors, the vaporizer cartridge 1320 may experience a change from a first pressure state to a second pressure state (e.g., a first relative pressure differential between the interior of the reservoir 140 and ambient pressure and a second relative pressure differential between the interior of the reservoir 140 and ambient pressure). For example, in the first pressure state, the pressure inside the reservoir 140 may be less than an ambient pressure external to the reservoir 140. Contrastingly, in the second pressure state, the pressure inside the reservoir 140 may exceed the ambient pressure. When the vaporizer cartridge 1320 is in an equilibrium state, the pressure inside the reservoir 140 may be substantially equal to the ambient pressure external to the reservoir 140.

In some aspects, the overflow volume 1344 may have the air vent 1318 to the exterior of cartridge 1320 and may be in communication with the reservoir storage chamber 1342 so that the overflow volume 1344 may act as a venting channel to provide for the equalization of pressure in the reservoir 140, collect and at least temporarily retain the vaporizable material 1302 entering the overflow volume 1344 (e.g., from the storage chamber 1342 in response to variations in a pressure differential between the storage chamber 1342 and ambient pressure), and/or optionally reversibly return at least a portion of the vaporizable material 1302 collected in the overflow volume 1344.

As used herein, a “pressure differential” may refer to a difference between a pressure within an internal part of the vaporizer cartridge 1320 and an ambient pressure external to the vaporizer cartridge 1320. Drawing the vaporizable material 1302 from the storage chamber 1342 to the atomizer 141 (e.g., the wicking element 1362 and the heating element 1350) for conversion to vapor or aerosol phases may reduce the volume of the vaporizable material 1302 remaining in the storage chamber 1342. Absent a mechanism for returning air into the storage chamber 1342 (e.g., to increase the pressure inside the vaporizer cartridge 1320 to achieve a substantial equilibrium with ambient pressure), low pressure or even a vacuum may develop within the vaporizer cartridge 1320. The low pressure or vacuum may interfere with the capillary action of the wicking element 1362 to draw additional quantities of the vaporizable material 1302 to the heating element 1350.

Alternatively, the pressure inside of the reservoir 140 can also increase and exceed the ambient pressure external to the reservoir 140 due to various environmental factors such as, for example, a change in ambient temperature, altitude, and/or volume of the reservoir 140. For example, the pressure inside of the reservoir 140 may increase when the vaporizer cartridge 1320 is subject to compression. This increase in internal pressure may sometimes occur after air is returned into the storage chamber 1342 to achieve an equilibrium between the pressure inside the reservoir 140 and the ambient pressure external to the reservoir 140. However, it should be appreciated that a sufficient change in one or more environmental factors may cause the pressure in the reservoir 140 to increase from below ambient pressure to above ambient pressure (e.g., transition from the first pressure state to the second pressure state) without any additional air entering the reservoir 140 to first achieve an equilibrium between the pressure inside the reservoir 140 and ambient pressure. The resulting negative pressure event in which the pressure inside the reservoir 140 undergoes a sufficient increase may displace at least a portion of the vaporizable material 1302 in the storage chamber 1342. Absent a mechanism for collecting and/or retaining the displaced vaporizable material 1302 within the vaporizer cartridge 1320, the displaced vaporizable material 1302 may leak from the vaporizer cartridge 1320.

Continuing to refer to FIGS. 2A and 2B, the reservoir 140 may be implemented to include a first area and a second area that is separable from the first area, such that the volume of the reservoir 140 is divided into the storage chamber 1342 and the overflow volume 1344. The storage chamber 1342 may be configured to store the vaporizable material 1302 and may be further coupled to the wicking element 1362 via one or more primary passageways 1382. In some examples, a primary passageway 1382 may be very short in length (e.g., a pass-through hole from a space containing the wicking element 1362 or other parts of the atomizer 141). In other examples, the primary passageway 1382 may be part of a longer fluid path between the storage chamber 1342 and the wicking element 1362. The overflow volume 1344 may be configured to collect and at least temporarily retain one or more portions of the vaporizable material 1302 that may enter the overflow volume 1344 from the storage chamber 1342 in the second pressure state in which the pressure in the storage chamber 1342 is greater than ambient pressure, as provided in further detail below.

In the first pressure state, the vaporizable material 1302 may be stored in the storage chamber 1342 of the reservoir 140. As noted, the first pressure state may exist, for example, when the ambient pressure external to the vaporizer cartridge 1320 is approximately the same as or more than the pressure inside the vaporizer cartridge 1320. In this first pressure state, the structural and functional properties of the primary passageway 1382 and the overflow channel 1104 are such that the vaporizable material 1302 may flow from the storage chamber 1342 toward the wicking element 1362 by way of the primary passageway 1382. For example, capillary action of the wicking element 1362 may draw the vaporizable material 1302 into proximity with the heating element 1350. Heat generated by the heating element 1350 may act on the vaporizable material 1302 to convert the vaporizable material 1302 to a gas phase.

In the first pressure state, none or a limited quantity of the vaporizable material 1302 may flow into the collector 1313, for example, into the overflow channel 1104 of the collector 1313. Contrastingly, when the vaporizer cartridge 1320 transitions from the first pressure state to the second pressure state, the vaporizable material 1302 may flow from the storage chamber 1342 into the overflow volume 1344 of the reservoir 140. By collecting and at least temporarily retaining the vaporizable material 1302 entering the collector 1313, the collector 1313 may prevent or limit an undesirable (e.g., excessive) flow of the vaporizable material 1302 out of the reservoir 140. As noted, the second pressure state may exist when the ambient pressure external to the vaporizer cartridge 1320 is less than the pressure inside the vaporizer cartridge 1320. This pressure differential may cause an expanding air bubble inside the storage chamber 1342, which may displace a portion of the vaporizable material 1302 inside the storage chamber 1342. The displaced portion of the vaporizable material 1302 may be collected and at least temporarily retained by the collector 1313 instead of exiting the vaporizer cartridge 1320 to cause undesirable leakage.

Advantageously, flow of the vaporizable material 1302 may be controlled by way of routing the vaporizable material 1302 driven from the storage chamber 1342 to the overflow volume 1344 in the second pressure state. For example, the collector 1313 within the overflow volume 1344 may include one or more capillary structures configured to collect and at least temporarily retain that contain at least some (and advantageously all) of the excess liquid vaporizable material 1302 pushed out of the storage chamber 1342 without allowing the liquid vaporizable material 1302 to reach an outlet of the collector 1313 where the liquid vaporizable material 1302 may exit the collector 1313 to cause undesirable leakage. The collector 1313 may also advantageously include capillary structures that enable the liquid vaporizable material pushed into the collector 1313 (e.g., by excess pressure in the storage chamber 1342 relative to ambient pressure) to be reversibly drawn back into the storage chamber 1342 when the pressure inside the storage chamber 1342 reduces and/or equalizes relative to ambient pressure. In other words, the overflow channel 1104 of the collector 1313 may have microfluidic features or properties that prevent air and the vaporizable material 1302 from bypassing each other during filling and emptying of the collector 1313. That is, microfluidic features may be used to manage the flow of the vaporizable material 1302 both into and out of the collector 1313 (i.e., provide flow reversal features). In doing so, these microfluidic features may prevent or reduce leakage of the vaporizable material 1302 as well as the entrapment of air bubbles in the storage chamber 1342 and/or the overflow volume 1344.

Depending on the implementation, the microfluidic features or properties noted above may be related to the size, shape, surface coating, structural features, and/or capillary properties of the wicking element 1362, the primary passageway 1382, and/or the overflow channel 1104. For example, the overflow channel 1104 in the collector 1313 may optionally have different capillary properties than the primary passageway 1382 leading to the wicking element 1362 such that a certain volume of the vaporizable material 1302 may be allowed to pass from the storage chamber 1342 into the overflow volume 1344, during the second pressure state in which at least a portion of the vaporizable material 1302 inside the storage chamber 1342 is displaced from the storage chamber 1342.

In one example implementation, the overall resistance of the collector 1313 to allowing liquid to flow out of the collector 1313 may be larger than an overall resistance of the wicking element 1362, for example, to allow the vaporizable material 1302 to primarily flow through the primary passageway 1382 toward the wicking element 1362 during the first pressure state.

The primary passageway 1382 may provide a capillary pathway through or into the wicking element 1362 for the vaporizable material 1302 stored in reservoir 140. The capillary pathway (e.g., the primary passageway 1382) may be large enough to permit a wicking action or capillary action to replace the vaporized vaporizable material 1302 in the wicking element 1362 but small enough to prevent leakage of the vaporizable material 1302 out of the vaporizer cartridge 1320 when excess pressure inside the vaporizer cartridge 1320 displaces at least a portion of the vaporizable material 1302 from the storage chamber 1342. The wick housing or the wicking element 1362 may be treated to prevent leakage. For example, the vaporizer cartridge 1320 may be coated after filling to prevent leakage or evaporation through the wicking element 1362. Any appropriate coating may be used, including, for example, a heat-vaporizable coating (e.g., a wax or other material) and/or the like.

When a user inhales from the mouthpiece area 1330 of the vaporizer cartridge 1320, air may flow into the vaporizer cartridge 1320 through the air vent 1318, which may be in operational relationship with the wicking element 1362. The heating element 1350 may be activated in response to a signal generated by the one or more sensors 113 (shown in FIG. 1). As noted, the one or more sensors 113 may include at least one of pressure sensor, motion sensor, flow sensor, or other mechanism capable of detecting a puff and/or an imminent puff including, for example, by detecting changes in the airflow passageway 1338. When the heating element 1350 is activated, the heating element 1350 may undergo a temperature increase as a result of a current flowing through the plates 1326 or through another electrically resistive part of the heating element 1350 that acts to convert electrical energy to heat energy. It should be appreciated that activating the heating element 1350 may include the controller 104 (e.g., shown in FIG. 1) controlling the power source 112 to discharge an electric current from the power source 112 to the heating element 1350.

Heat generated by the heating element 1350 may be transferred to at least a portion of the vaporizable material 1302 in the wicking element 1362 through conductive, convective, and/or radiative heat transfer such that at least a portion of the vaporizable material 1302 drawn into the wicking element 1362 is vaporized. Depending on implementation, air entering the vaporizer cartridge 1320 may flow over (or around, near, etc.) the wicking element 1362 and the heated elements in the heating element 1350 and may strip away the vaporized vaporizable material 1302 into the airflow passageway 1338, where the vapor may optionally be condensed and delivered in aerosol form, for example, through the orifice 220 in the mouthpiece area 1330.

Referring to FIG. 2B, the storage chamber 1342 may be connected to the airflow passageway 1338 (i.e., via the overflow channel 1104 of overflow volume 1344) for the purpose of allowing the portions of the liquid vaporizable material 1302 driven from the storage chamber 1342 by increased pressure in the storage chamber 1342 relative to ambient to be retained in the overflow volume 1344 without escaping from the vaporizer cartridge 1320. While the implementations described herein relate to the vaporizer cartridge 1320 including the reservoir 140, it will be understood that the approaches described are also compatible with and contemplated for use in a vaporizer without a separable cartridge.

Returning to the example, air, which may be admitted to the storage chamber 1342 when the pressure inside the vaporizer cartridge 1320 is lower than ambient pressure, may increase the pressure inside the vaporizer cartridge 1320 and may cause the vaporizer cartridge 1320 to transition to the second pressure state in which the pressure inside the vaporizer cartridge 1320 exceed the ambient pressure external to the vaporizer cartridge 1320. Alternatively and/or additionally, the vaporizer cartridge 1320 may transition to the second pressure state in response to a change in ambient temperature, a change in ambient pressure (e.g., due to a change in external conditions such as altitude, weather, and/or the like), and/or a change in the volume of the vaporizer cartridge 1320 (e.g., when the vaporizer cartridge 1320 is compacted by an external force such as squeezing). The increase in the pressure inside the storage chamber 1342, for example, in the case of a negative pressure event, may at least expand the air occupying the void space of the storage chamber 1342, thereby displacing at least a portion of the liquid vaporizable material 1302 in the storage chamber 1342. The displaced portion of the vaporizable material 1302 may travel through at least some part of the overflow channel 1104 in the collector 1313. Microfluidic features of the overflow channel 1104 can cause the liquid vaporizable material 1302 to move along a length of the overflow channel 1104 in the collector 1313 only with a meniscus fully covering the cross-sectional area of the overflow channel 1104 transverse to the direction of flow along the length.

In some implementations of the current subject matter, the microfluidic features can include a cross-sectional area sufficiently small that for the material from which walls of the overflow channel 1104 are formed and the composition of the liquid vaporizable material 1302, the liquid vaporizable material 1302 preferentially wets the overflow channel 1104 around an entire perimeter of the overflow channel 1104. For an example in which the liquid vaporizable material 1302 includes one or more of propylene glycol and vegetable glycerin, wetting properties of such a liquid are advantageously considered in combination with the geometry of the second passageway 1384 and materials form which the walls of the overflow channel 1104 are formed. In this manner, as the sign (e.g., positive, negative, or equal) and magnitude of the pressure differential between the storage chamber 140 and ambient pressure varies, a meniscus is maintained between the liquid vaporizable material 1302 present in the overflow channel 1104 and air entering from the ambient atmosphere to prevent the vaporizable material 1302 and the air from moving past one another.

As pressure in the storage chamber 1342 drops sufficiently relative to ambient pressure and if there is sufficient void volume in the storage chamber 1342 to allow it, the vaporizable material 1302 present in the overflow channel 1104 of the collector 1313 may be withdrawn into the storage chamber 1342 sufficiently to cause the leading liquid-air meniscus to reach a gate or port between the overflow channel 1104 of the collector 1313 and the storage chamber 1342. At such time, if the pressure differential in the storage chamber 1342 relative to ambient pressure is sufficiently negative to overcome surface tension maintaining the meniscus at the gate or port, the meniscus may be freed from the gate or port walls to form one or more air bubbles, which are then released into the storage chamber 1342 with sufficient volume to equalize the pressure inside the storage chamber 1342 relative to ambient pressure.

When air admitted into the storage chamber 140 as discussed above (or otherwise becomes present therein) experiences an elevated pressure condition relative to ambient (e.g., due to a drop in ambient pressure such as might occur in an airplane cabin or other high altitude locations, when a window of a moving vehicle is opened, when a train or vehicle leaves a tunnel, etc. or an elevation in internal pressure in the storage chamber 140 such as might occur due to local heating, mechanical pressure that distorts a shape and thereby reduces a volume of the storage chamber 140, etc., or the like), the above-described process may be reversed. Liquid passes through the gate or port into the overflow channel 1104 of the collector 1313 and a meniscus forms at the leading edge of a column of the vaporizable material 1302 passing into the overflow channel 1104 to prevent air from bypassing and flowing counter to the progression of the vaporizable material 1302.

By maintaining this meniscus due to the presence of the aforementioned microfluidic properties, when the elevated pressure in the storage chamber 140 is later reduced, the column of vaporizable material 1302 may be withdrawn back into the storage chamber 140, and optionally until the meniscus reaches the gate or port. If the pressure differential sufficiently favors ambient pressure relative to the pressure inside the storage chamber 1342, the above-described bubble formation process may occur until the two pressures equalize. In this manner, the collector 1313 may act as a reversible overflow volume that accepts the vaporizable material 1302 that is pushed out of the storage chamber 1342 under transient conditions of greater storage chamber pressure relative to ambient pressure while allowing at least some (and desirably all or most) of this overflow volume of vaporizable material 1302 to be returned to the storage chamber 140 for later delivery, for example, to the heating element 1350 for conversion to an inhalable aerosol.

Depending on implementation, the storage chamber 1342 may or may not be connected to the wicking element 1362 via the overflow channel 1104. In embodiments in which the overflow channel 1104 includes a first end coupled with the storage chamber 1342 and a second end overflow channel 1104 leading to the wicking element 1362, any of the vaporizable material 1302 that may exit the overflow channel 1104 at the second end may further saturate the wicking element 1362.

The storage chamber 1342 may optionally be positioned closer to an end of the reservoir 140 that is near the mouthpiece area 1330. The overflow volume 1344 may be positioned near an end of the reservoir 140 closer to the heating element 1350, for example, between the storage chamber 1342 and the heating element 1350. The example embodiments shown in the figures are not to be construed as limiting the scope of the claimed subject matter as to the position of the various components disclosed herein. For example, the overflow volume 1344 may be positioned at a top portion, a middle portion, or a bottom portion of the vaporizer cartridge 1320. The location and positioning of the storage chamber 1342 may be adjusted relative to the position of the overflow volume 1344, such that the storage chamber 1342 may be positioned at the top portion, middle portion, or bottom portion of the vaporizer cartridge 1320 according to one or more variations.

In one implementation, when the vaporizer cartridge 1320 is filled to capacity, the volume of liquid vaporizable material 1302 may be equal to the internal volume of the storage chamber 1342 plus the overflow volume 1344. The internal volume of the overflow volume may, in some example implementations, correspond to a volume of the overflow channel 1104 between a gate or port connecting the overflow channel 1104 to the storage chamber 140 and an outlet of the overflow channel 1104. In other words, the vaporizer cartridge 1320 may be initially filled with liquid vaporizable material 1302 such that all or at least some of the internal volume of the collector 1313 is occupied with the liquid vaporizable material 1302. In such an example, liquid vaporizable material 1302 may be delivered to the atomizer 141 (e.g., including the wicking element 1362 and the heating element 1350) as needed for delivery to a user. For example, to deliver a portion of the vaporizable material 1302, the portion of the vaporizable material 1302 may be drawn from the storage chamber 140, thereby causing any vaporizable material 1302 present in the overflow channel 1104 of the collector 1313 to be drawn back into the storage chamber 140 because air cannot enter through the overflow channel 1104 due to the meniscus maintained by the microfluidic properties of the overflow channel 1104 (which prevents air from flowing past the vaporizable material 1302 present in the overflow channel 1104).

After a sufficient quantity of the vaporizable material 1302 has been delivered to the atomizer 141 from the storage chamber 140 (e.g., for vaporization and user inhalation) to cause the original volume of the collector 1313 to be drawn into the storage chamber 140, the above-discussed action occurs. For instance, one or more air bubbles may be released from a gate or port between the secondary passage 1384 and the storage chamber 140 to equalize pressure inside the storage chamber 140 (e.g., relative to ambient pressure) as a portion of the vaporizable material 1302 is removed from the storage chamber 140. When the pressure inside the storage chamber 140 increases above ambient pressure (e.g., due to the admission of air in the first pressure state, a change in temperature, a change in ambient pressure, a change in a volume of the vaporizer cartridge 1320, and/or the like), a portion of the liquid vaporizable material 1302 inside the storage chamber 140 may become displaced and thus move out of the storage chamber 140 past the gate or port into the overflow channel 1104 until the elevated pressure condition in the storage compartment subsides, at which point the liquid vaporizable material 1302 in the overflow channel 1104 may be drawn back into the storage chamber 140.

In certain embodiments, the overflow volume 1344 may be sufficiently large to contain a percentage of the vaporizable material 1302 stored in the storage chamber 1342, including up to approximately 100% of the capacity of the storage chamber 1342. In one embodiment, the collector 1313 may be configured to contain at least 6 percent to 25 percent of the volume of the vaporizable material 1302 storable in the storage chamber 1342. Other ranges are also within the scope of the current subject matter.

The structure of the collector 1313 may be configured, constructed, molded, fabricated or positioned in the overflow volume 1344, in different shapes and having different properties, to allow for overflowing portions of the vaporizable material 1302 to be at least temporarily received, contained or stored in the overflow volume 1314 in a controlled manner (e.g., by way of capillary pressure), thereby preventing the vaporizable material 1302 from leaking out of the vaporizer cartridge 1320 or excessively saturating the wicking element 1362. It will be understood that the above description referring to the overflow channel 1104 is not intended to be limiting to a single such overflow channel 1104. One, or optionally more than one, the overflow channel 1104 may be connected to the storage chamber 140 via one or more than one gate or port. In some implementations of the current subject matter, a single gate or port may connect to more than one overflow channel 1104, or a single overflow channel 1104 may split into more than one overflow channel 1104 to provide additional overflow volume or other advantages.

In some implementations of the current subject matter, an air vent 1318 may connect the overflow volume 1344 to the airflow passageway 1338 that ultimately leads to ambient air environment outside of the vaporizer cartridge 1320. This air vent 1318 may allow for a path for air or bubbles that may have been formed or trapped in the collector 1313 to escape through the air vent 1318, for example during the second pressure state in which the overflow channel 1104 fills with a portion of the vaporizable material 1302 displaced from the storage chamber 1342.

In accordance with some aspects, the air vent 1318 may act as a reverse vent and provide for the equalization of pressure within the vaporizer cartridge 1320 during a reverting back to an equilibrium state, from the second pressure state, as the overflow of the vaporizable material 1302 returns back to the storage chamber 1342 from the overflow volume 1344. In this implementation, as ambient pressure exceeds the internal pressure in the vaporizer cartridge 1320, ambient air may flow through the air vent 1318 into the overflow channel 1104 and effectively help push the vaporizable material 1302 temporarily stored in the overflow volume 1344 in a reverse direction back into the storage chamber 1342.

Referring again to FIGS. 2A-C, in one or more embodiments, in the first pressure state, the overflow channel 1104 may be at least partially occupied with air, which may enter the overflow channel 1104 through the air vent 1318. In the second pressure state, the vaporizable material 1302 may enter the overflow channel 1104, for example through a second opening 210b at a point of interface between the storage chamber 1342 and the overflow channel 1104 of the overflow volume 1344. As a result, air in the overflow channel 1104 may become displaced (e.g., by the incoming vaporizable material 1302) and may exit through the air vent 1318. In some embodiments, the air vent 1318 may act as or include a control valve (e.g., a selective osmosis membrane, a microfluidic gate, etc.) that allows for air to exit the overflow volume 1344, but blocks the vaporizable material 1302 from exiting from the overflow channel 1104 into the airflow passageway 1338. As noted earlier, the air vent 1318 may act as an air exchange port to allow air to enter and exit the collector 1313 as, for example, the collector 1313 fills with the vaporizable material 1302 displaced by excess pressure in the storage chamber 1342 and empties when the pressure inside the storage chamber 1342 substantially equalizes with ambient pressure. That is, the air vent 1318 may allow air to enter and exit the collector 1313 when during a transition between the first pressure state when the pressure inside the vaporizer cartridge 1320 is less than the ambient pressure, the second pressure state when the pressure inside the vaporizer cartridge 1320 exceeds the ambient pressure, and an equilibrium state when the pressure inside the vaporizer cartridge 1320 and the ambient pressure are substantially the same.

Accordingly, the vaporizable material 1302 may be stored in the collector 1313 until pressure inside the vaporizer cartridge 1320 is stabilized (e.g., when the pressure inside the vaporizer cartridge 1320 is substantially equal to ambient pressure or meets a designated equilibrium) or until the vaporizable material 1302 is removed from the overflow volume 1344 (e.g., by being drawn to the atomizer 141 including the wicking element 1362 and the heating element 1350 for vaporization). Thus, the level of the vaporizable material 1302 in the overflow volume 1344 may be controlled by managing the flow of vaporizable material 1302 into and out of the collector 1313 as ambient pressure changes. In one or more embodiments, overflow of the vaporizable material 1302 from the storage chamber 1342 into the overflow volume 1344 may be reversed or may be reversible depending on detected changes in environment (e.g., when a pressure event that caused the vaporizable material 1302 overflow subsides or is concluded).

As noted above, in some implementations of the current subject matter, in a state when pressure inside of the vaporizer cartridge 1320 becomes lower than the ambient pressure (e.g., when transitioning from the second pressure state back to the first pressure state), flow of the vaporizable material 1302 may be reversed in a direction that causes the vaporizable material 1302 to flow from the overflow volume 1344 back into the storage chamber 1342 of the reservoir 140. Thus, depending on implementation, the overflow volume 1344 may be configured for temporary retention of the overflow portions of the vaporizable material 1302 during the second pressure state when high pressure inside the vaporizer cartridge 1320 displaces at least a portion of the vaporizable material 1302 from the storage chamber 1342. Depending on an implementation, during or after a reversal back to the first pressure state when the pressure inside the vaporizer cartridge 1320 is substantially equal to or below ambient pressure, at least some of the overflow of the vaporizable material 1302 retained in the collector 1313 may be returned back to the storage chamber 1342.

To control the vaporizable material 1302 flow in the vaporizer cartridge 1320, in other implementations of the current subject matter, the collector 1313 may optionally include an absorbent or semi-absorbent material (e.g., material having sponge-like properties) for permanently or semi-permanently collecting or retaining the overflow of the vaporizable material 1302 travelling through the overflow channel 1104. In one example embodiment in which absorbent material is included in the collector 1313, the reverse flow of the vaporizable material 1302 from the overflow volume 1344 back into the storage chamber 1342 may not be as practical or possible as compared to embodiments that are implemented without (or without as much) absorbent material in the collector 1313. That is, the presence of the absorbent or semi-absorbent material may at least partially inhibit the vaporizable material 1302 collected in the overflow volume 1344 from returning back to the storage chamber 1342. Accordingly, the reversibility and/or the reversibility rate of the vaporizable material 1302 to the storage chamber 1342 may be controlled by including more or less densities or volumes of absorbent material in the collector 1313 or by controlling texture of the absorbent material, where such characteristics result in a higher or lower rate of absorption, either immediately or over longer time periods.

FIGS. 2D-E depict cross sectional views of examples of the vaporizer cartridge 1320 consistent with implementations of the current subject matter. As noted, in some implementations of the current subject matter, the vaporizer cartridge 1320 may include one or more microfluidic features configured to prevent air and the vaporizable material 1302 from bypassing each other during filling and emptying of the collector 1313. These microfluidic features, which manage the flow of the vaporizable material 1302 into and out of the collector 1313, may minimize leakage of the vaporizable material 1302 as well as the entrapment of air bubbles in the storage chamber 1342 and/or the overflow volume 1344.

In some implementations of the current subject matter, the collector 1313 of the vaporizer cartridge 1320 may include the overflow channel 1104. Referring again to FIGS. 2D-E, a first end of the overflow channel 1104 may include the air vent 1318 in fluid communication with the airflow passageway 1338 while a second end of the overflow channel 1104 may include the second opening 210b in fluid communication with the storage chamber 1342. Accordingly, the vaporizable material 1302 may enter and exit the overflow channel 1104 through the second opening 210b while air may enter and exit the overflow channel 1104 through the air vent 1318. For example, as noted, air entering through the air vent 1318 may relieve any vacuum that may develop within the reservoir 140 due to the depletion of the vaporizable material 1302. Alternatively, at least a portion of the vaporizable material 1302 in the storage chamber 1342 may enter the overflow channel 1104 through the second opening 210b during a negative pressure event where the vaporizable material 1302 is displaced from the storage chamber 1342 due to an increase in the pressure inside the reservoir 140. FIGS. 2D-E depict examples of the vaporizer cartridge 1320 having a different placement of the air vent 1318 and the second opening 210b.

Referring to FIG. 2D, in some implementations of the current subject matter, the air vent 1318 may be disposed adjacent to the wick housing 1315 and the wicking element 1362 while the second opening 210b is disposed away from the wick housing 1315 and the wicking element 1362, for example, above the air vent 1318. Alternatively, in the example of the vaporizer cartridge 1320 shown in FIG. 2E, the second opening 210b may be disposed adjacent to the wick housing 1315 and the wicking element 1362 while the air vent 1318 may be disposed away from the wick housing and the wicking element 1362, for example, above the second opening 210b. It should be appreciated that proximity between the wicking element 1362 and the second opening 210b, which is in fluid communication with the storage chamber 1342, may minimize the hydrostatic head between the wicking element 1362 and the storage chamber 1342. As such, the example of the vaporizer cartridge 1320 shown in FIG. 2E may be more resilient to leakage through the wicking element 1362 because the negative pressure created by the meniscus at the second opening 210b is preserved instead of being diminished by the hydrostatic head between the wicking element 1362 and the storage chamber 1342.

In some implementations of the current subject matter, the overflow channel 1104 may include one or more microfluidic features including, for example, a first microfluidic feature 230a, a second microfluidic feature 230b, and/or the like. The first microfluidic feature 230a and/or the second microfluidic feature 230b may be configured to control the flow of air and the vaporizable material 1302 into and out of the reservoir 140. For example, the first microfluidic feature 230a and/or the second fluid features 230b may be configured to discourage the flow of the vaporizable material 1302 in one direction the overflow channel 1104 (e.g., away from the storage chamber 1342 and out of the overflow channel 1104) and encourage the flow of the vaporizable material 1302 in a reverse direction (e.g., back into the storage chamber 1342). Moreover, the first microfluidic feature 230a and the second microfluidic feature 230b may be configured to permit airflow to the storage chamber 1342 through the overflow channel 1104 in order to equalize the pressure inside the storage chamber 1342 with ambient pressure.

One example of a microfluidic feature may be one or more constriction points in which the cross sectional shape and/or dimensions of the overflow channel 1104 vary across a length of the overflow channel 1104. As shown in FIG. 2D, the first microfluidic feature 230a may be a type of constriction point in which the cross sectional shape and/or dimensions of the overflow channel 1104 at a first portion of the overflow channel 1104 differs from a cross sectional shape and/or dimensions of the overflow channel 1104 at a second portion of the overflow channel 1104 and/or a third portion of the overflow channel 1104 at either side of the first portion of the overflow channel 1104. For example, constriction points may be formed by one or more bumps, raised edges, and/or protrusions extending from an interior surface of the overflow channel 1104.

To further illustrate, FIG. 2F depicts a planar cross-sectional view of the collector 1313 having an example of the first microfluidic feature 230a consistent with implementations of the current subject matter. Referring to FIG. 2F, the first microfluidic feature 230a may be a bump, a raised edge, a protrusion, or another form of a constriction point extending from an interior surface of the overflow channel 1104. In some implementations of the current subject matter, the shape of the first microfluidic feature 230a may be defined as a bump, finger, prong, fin, edge, or any other shape that constricts a cross-sectional area transverse to a flow direction in the overflow channel 1104. For example, the first microfluidic features 230a may be in the shape of a shark fin, for example, in which the distal end of the first microfluidic feature 230a tapers to an edge. The pointed or cantilevered edge of the shark fin shape may be rounded although the cantilevered edge may also be tapered to a sharp end.

Other examples of microfluidic features may include one or more variations in the shape and/or orientation of the overflow channel 1104 along a length of the overflow channel 1104. For example, in some implementations of the current subject matter, at least a portion of the overflow channel 1104 may spiral, curve, bend, taper, turn, and/or slope. To further illustrate, FIG. 2D shows that the second microfluidic feature 230b may be a curvature in the overflow channel 1104 where the overflow channel 1104 running in one direction turns in an opposite direction. It should be appreciated that the shape, size, relative location, and total quantity of microfluidic features disposed along the length of the overflow channel 1104 may be adjusted to further control the ingress and egress of the vaporizable material 1302 into and out of the overflow channel 1104, for example, by fine-tuning a tendency of a meniscus (e.g., separating the vaporizable material 1302 and air) to form within the overflow channel 1104.

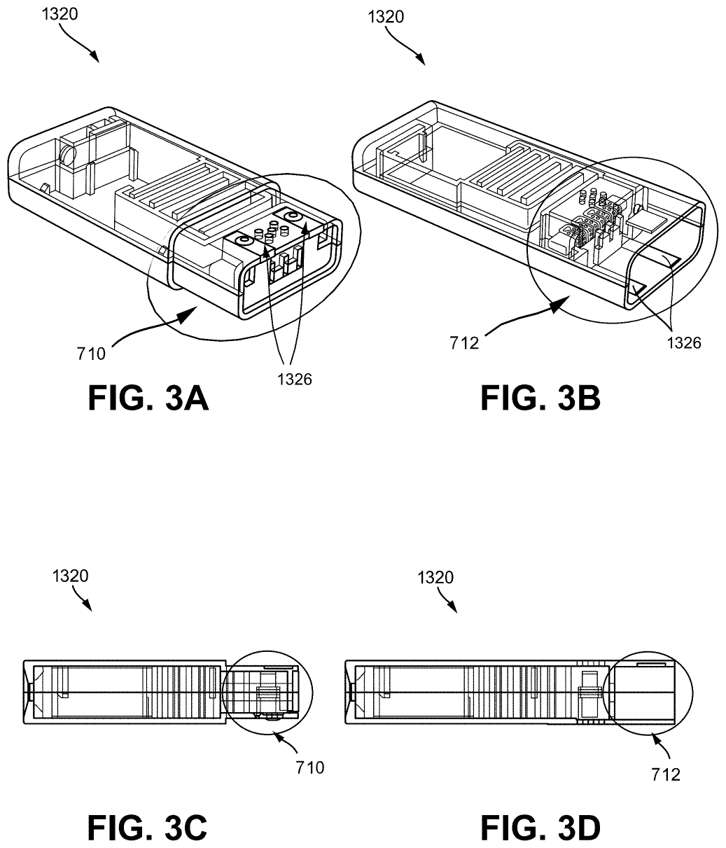

In some implementations of the current subject matter, the vaporizer cartridge 1320 may couple with the vaporizer body 110 of the vaporizer device 100 in a variety of different manners. For example, FIGS. 3A-D depict various design alternatives for connectors configured to form a coupling between the vaporizer cartridge 1320 and the vaporizer body 110 of the vaporizer device 100. FIGS. 3A-B each depict perspective views of various examples of the connectors while FIGS. 3C-D each depict planar cross-sectional side views of various examples of the connectors.

The examples of the connectors shown in FIGS. 3A-D may include complementary male connectors (e.g., protrusions) and female connectors (e.g., receptacles). As shown in FIGS. 1, 2A-B, and 3A-D, one end of the vaporizer cartridge 1320 may include one or more connectors to enable a coupling between the vaporizer cartridge 1320 and the vaporizer body 110 of the vaporizer device 100. For example, one end of the vaporizer cartridge 1320 may include one or more mechanical connectors, electrical connectors, and fluid connectors configured to provide an electrical coupling, a mechanical coupling, and/or a fluid coupling between the vaporizer cartridge 1320 and the vaporizer body 110. It should be appreciated that these connectors may be implemented with various configurations.

In one implementation of the current subject matter, one end of the vaporizer cartridge 1320 may include a male connector 710 (e.g., a protrusion) that is configured to couple with a female connector (e.g., the cartridge receptacle 118) in the vaporizer body 110. In this example, when the vaporizer cartridge 1320 is coupled with the vaporizer body 110, the contacts 1326 disposed on the male connector 710 may form an electric coupling with the corresponding receptacle contacts 125 in the cartridge receptacle 118. Moreover, the contacts 1326 on the male connector 710 may mechanically engage the receptacle contacts 125 in the cartridge receptacle, for example, by friction fit (e.g., snap-lock engagement) and/or spring tension, to secure the vaporizer cartridge 1320 in the cartridge receptacle 118 of the vaporizer body 110.

Alternatively, FIGS. 3B and 3D depicts another example of the vaporizer cartridge 1320 in which one end of the vaporizer cartridge 1320 includes a female connector 712. The female connector 712 may be a receptacle that is configured to receive a corresponding male connector (e.g., a protrusion) on the vaporizer body 110. In this example implementation, the contacts 1326 may be disposed inside the female connector 712 and may be configured to form an electric coupling as well as a mechanical coupling with corresponding contacts on the male connector on the vaporizer body 110.

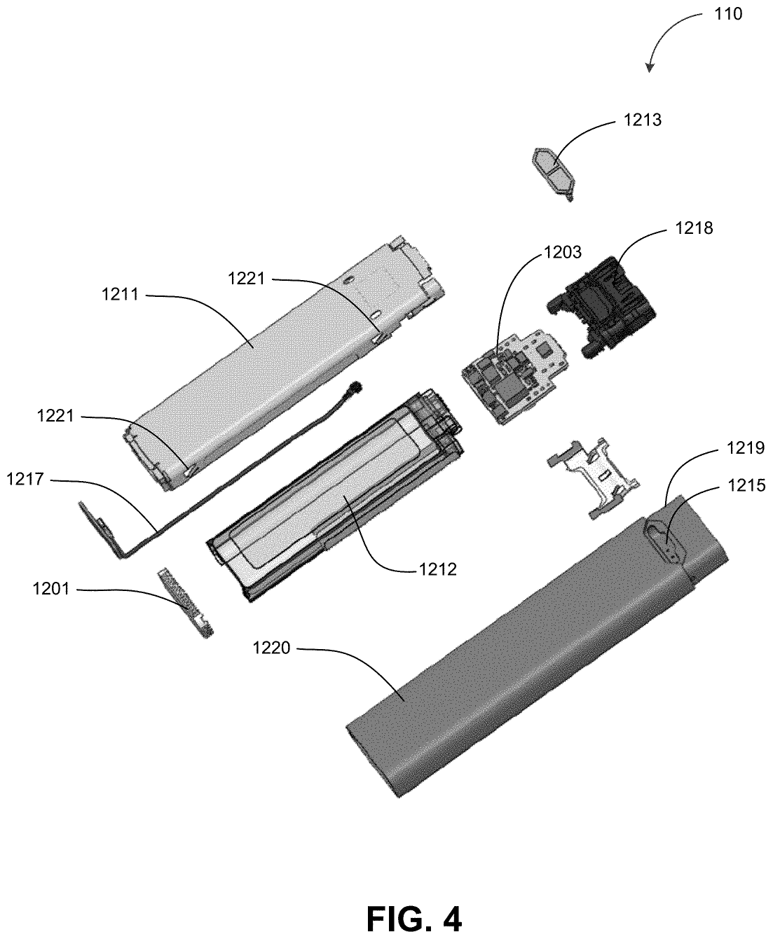

FIG. 4 depicts an exploded view of an example of the vaporizer body 110 consistent with implementations of the current subject matter. In some implementations of the current subject matter, the vaporizer body 110 may be configured to receive and/or couple with a cartridge having various features described above including, for example, the cartridge 1320 having the collector 1313, the finned condensate collector 352, and/or the like.

As shown in FIG. 4, the vaporizer body 110 may include a shell 1220, a sheath 1219, a battery 1212, a printed circuit board assembly (PCBA) 1203, an antenna 1217, a skeleton 1211, a charge badge 1213, a cartridge interface 1218, an endcap 1201, and an LED badge 1215. In some aspects, assembly of the vaporizer body 110 includes placing the battery 1212 within the skeleton 1211 at an inferior end of the skeleton 1211 (left-hand side of FIG. 4). The antenna 1217 may be coupled to an inferior end of the battery 1212. The cartridge interface 1218, the PCBA 1203, and the battery 1212 may be mechanically coupled, for example, via one or more coupling means. For example, an inferior end of the PCBA 1203 may be coupled to a superior end of the battery 1212 and a superior end of the PCBA 1203 may be coupled to the cartridge interface 1218 using press fits, solder joints, and/or any other coupling means. To form the cartridge interface 1218, the sheath 1219 may be configured to at least partially surround the cartridge interface 1218 when the cartridge interface 1218 is disposed in the sheath 1219. When disposed in the shell 1220, the skeleton 1211 (e.g., including the battery 1212, the antenna 1217, the cartridge interface 1218, and the PCBA 1203) may be secured to the shell 1220 by friction fit, spring tension, and/or the like. For instance, as show in FIG. 4, the skeleton 1211 may include one or more snap features 1221 configured to engage the shell 1220.

In some implementations of the current subject matter, the vaporizer body 110 may include one or more features configured to maximize the range of the antenna 1217. For example, the shell 1220 may be formed from a first material (e.g., metal and/or the like) that may block the radio waves from the antenna 1217. Even if the endcap 1201 is formed from a second material (e.g., plastic and/or the like) that is penetrable to the radio waves from the antenna 1217, the range of the antenna 1217 may nevertheless be compromised if the endcap 1201 is disposed substantially within the shell 1220 (e.g., such that an exterior surface of the endcap 1201 lies substantially flush against one end of the shell 1201). Accordingly, to maximize the range of the antenna 1217, the shell 1220 formed from the first material may include one or more insets formed from the second material that is penetrable to the radio waves from the antenna 1217. Alternatively and/or additionally, one or more strategies, such as beamforming, may be implemented to maximize the power of the radio waves irradiating from the endcap 1310 and/or those portions of the shell 1220 formed from the second material.

Referring again to FIG. 4, the sheath 1219 may include an aperture sized and shaped to receive the charge badge 1213 on a first side of the sheath 1219. A second side of the sheath 1219 may include the LED badge 1215, which may be built into the sheath 1219 or disposed in another aperture sized and shaped to receive the LED badge 1215. In some aspects, the sheath 1219 may include a stainless steel material and may have a thickness of approximately 0.2 mm. The LED badge 1215 may be molded with a black printed circuit. In some aspects, the charge badge 1213 may include a liquid crystal polymer (LCP), polycarbonate, and/or phosphor bronze contacts. The charge badge 1213 may minimize distance between charge pads by using a mylar film. A plating of the charge badge may include palladium-nickel, black nickel, physical vapor deposition (PVD), or another black plating option. In some implementations, the assembled battery 1212, PCBA 1203, the cartridge interface 1218, and sheath 1219 may be configured to fit within the skeleton 1211 and the skeleton 1211 may be configured to fit within the shell 1220. In some aspects, the sheath 1219 may be formed from a material, such as a stainless steel, that minimizes the thickness of the sheath 1219 (e.g., approximately 0.2 mm). The shell 1220 may include grounding pads, an endcap datum, an LED interface, one or more air inlets (that are in fluid communication with the airflow slots at the bottom of the wick housing 1315 when the cartridge 1320 is coupled with the vaporizer body 110), and the snap features 1221 where the skeleton 1211 snaps into place when inserted into the shell 1220. The endcap 1201 may be disposed at an inferior end of the shell 1220 opposite the sheath 1219. The endcap 1201 may be configured to retain the interior components of the vaporizer body 210 within the shell 1220 and may also serve as a vent on the inferior end of the shell 1220.

In vaporizers in which the power source 112 is part of a vaporizer body 110 and a heating element is disposed in a vaporizer cartridge 1320 configured to couple with the vaporizer body 110, the vaporizer 100 may include electrical connection features (e.g., means for completing a circuit) for completing a circuit that includes the controller 104 (e.g., a printed circuit board, a microcontroller, or the like), the power source, and the heating element. These features may include at least two contacts 124 on a bottom surface of the vaporizer cartridge 1320 (referred to herein as cartridge contacts 124) and at least two contacts 125 disposed near a base of the cartridge receptacle (referred to herein as receptacle contacts 125) of the vaporizer 100 such that the cartridge contacts 124 and the receptacle contacts 125 make electrical connections when the vaporizer cartridge 1320 is inserted into and coupled with the cartridge receptacle 118. The circuit completed by these electrical connections can allow delivery of electrical current to the resistive heating element and may further be used for additional functions, such as for example for measuring a resistance of the resistive heating element for use in determining and/or controlling a temperature of the resistive heating element based on a thermal coefficient of resistivity of the resistive heating element, for identifying a cartridge based on one or more electrical characteristics of a resistive heating element or the other circuitry of the vaporizer cartridge, etc.

In some examples of the current subject matter, the at least two cartridge contacts and the at least two receptacle contacts can be configured to electrically connect in either of at least two orientations. For example, one or more circuits necessary for operation of the vaporizer can be completed by insertion of a vaporizer cartridge 1320 in the cartridge receptacle 118 in a first rotational orientation (around an axis along which the end of the vaporizer cartridge having the cartridge is inserted into the cartridge receptacle 118 of the vaporizer body 110) such that a first set of cartridge contacts of the at least two cartridge contacts 124 is electrically connected to a first set of receptacle contacts of the at least two receptacle contacts 125 and a second set of cartridge contacts of the at least two cartridge contacts 124 is electrically connected to a second set of receptacle contacts of the at least two receptacle contacts 125. Furthermore, the one or more circuits necessary for operation of the vaporizer can be completed by insertion of a vaporizer cartridge 1320 in the cartridge receptacle 118 in a second rotational orientation such that the first set of cartridge contacts of the at least two cartridge contacts 124 is electrically connected to the second set of receptacle contacts of the at least two receptacle contacts 125 and the second set of cartridge contacts of the at least two cartridge contacts 124 is electrically connected to the first set of receptacle contacts of the at least two receptacle contacts 125. This feature of a vaporizer cartridge 1320 being reversibly insertable into a cartridge receptacle 118 of the vaporizer body 110 is described further below.

In one example of an attachment structure for coupling a vaporizer cartridge 1320 to the vaporizer body 110, the vaporizer body 110 includes one or more detents (e.g., a dimple, protrusion, spring connector, etc.) protruding inwardly from an inner surface the cartridge receptacle 118. One or more exterior surfaces of the vaporizer cartridge 1320 can include corresponding recesses (not shown in FIG. 1) that can fit and/or otherwise snap over such detents when an end of the vaporizer cartridge 1320 inserted into the cartridge receptacle 118 on the vaporizer body 110. When the vaporizer cartridge 1320 and the vaporizer body 110 are coupled (e.g., by insertion of an end of the vaporizer cartridge 1320 into the cartridge receptacle 118 of the vaporizer body 110), the detent into the vaporizer body 110 may fit within and/or otherwise be held within the recesses of the vaporizer cartridge 1320 to hold the vaporizer cartridge 1320 in place when assembled. Such a detent-recess assembly can provide enough support to hold the vaporizer cartridge 1320 in place to ensure good contact between the at least two cartridge contacts 124 and the at least two receptacle contacts 125, while allowing release of the vaporizer cartridge 1320 from the vaporizer body 110 when a user pulls with reasonable force on the vaporizer cartridge 1320 to disengage the vaporizer cartridge 1320 from the cartridge receptacle 118. For example, in one implementation of the current subject matter, at least two detents may be disposed on an exterior of the sheath 1219. The detents on the exterior of the sheath 1219 may be configured to engage one or more corresponding recesses in the vaporizer cartridge 1320, for example, in an interior surface of a portion of the housing of the vaporizer cartridge 1320 that extends below an open top of the sheath 1219 (and the cartridge interface 1218) to cover at least a portion of the sheath 1219 (and cartridge receptacle 118).

Further to the discussion above about the electrical connections between a vaporizer cartridge and a vaporizer body being reversible such that at least two rotational orientations of the vaporizer cartridge in the cartridge receptacle are possible, in some vaporizers the shape of the vaporizer cartridge, or at least a shape of the end of the vaporizer cartridge that is configured for insertion into the cartridge receptacle may have rotational symmetry of at least order two. In other words, the vaporizer cartridge or at least the insertable end of the vaporizer cartridge may be symmetric upon a rotation of 180° around an axis along which the vaporizer cartridge is inserted into the cartridge receptacle. In such a configuration, the circuitry of the vaporizer 100 may support identical operation regardless of which symmetrical orientation of the vaporizer cartridge 1320 occurs. In some aspects, the first rotational position may be more than or less than 180° from the second rotational position.

In some examples, the vaporizer cartridge 1320, or at least an end of the vaporizer cartridge configured 1320 for insertion in the cartridge receptacle may have a non-circular cross section transverse to the axis along which the vaporizer cartridge is inserted into the cartridge receptacle 118. For example, the non-circular cross section may be approximately rectangular, approximately elliptical (e.g., have an approximately oval shape), non-rectangular but with two sets of parallel or approximately parallel opposing sides (e.g., having a parallelogram-like shape), or other shapes having rotational symmetry of at least order two. In this context, approximately having a shape indicates that a basic likeness to the described shape is apparent, but that sides of the shape in question need not be completely linear and vertices need not be completely sharp. Rounding of both or either of edges or vertices of the cross-sectional shape is contemplated in the description of any non-circular cross section referred to herein.

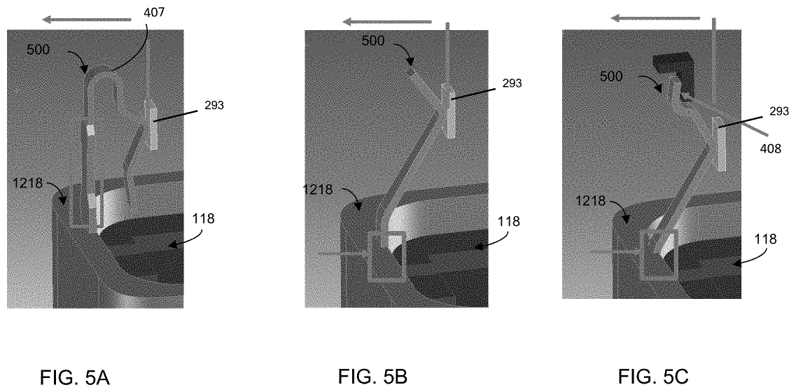

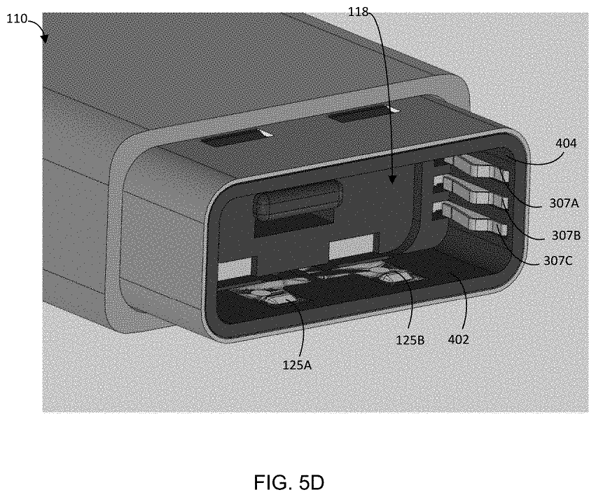

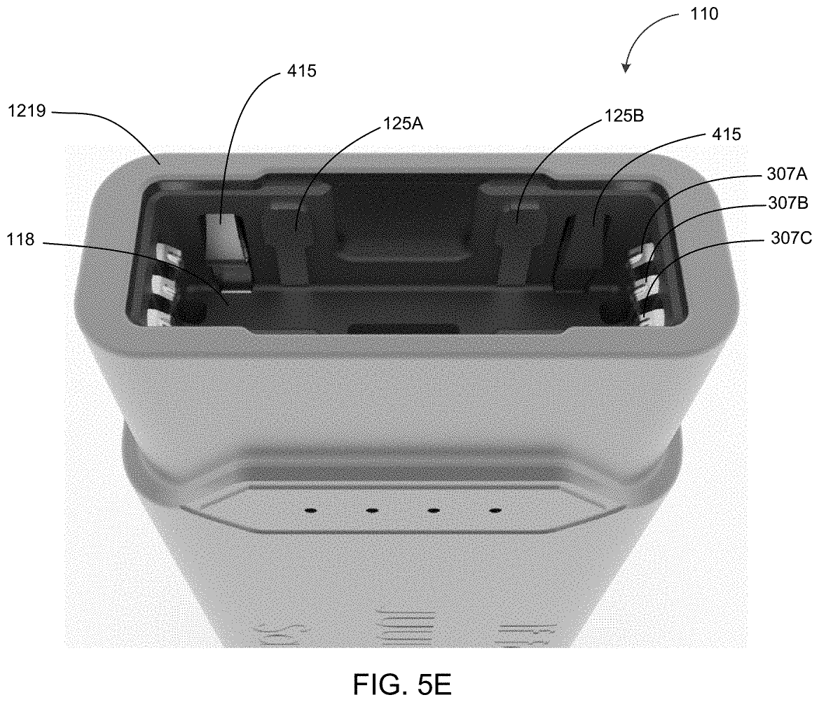

FIGS. 5A-C depicts various examples of a pod identifier contact 500 consistent with implementations of the current subject matter. As shown in FIGS. 5A-C, the pod identifier contact 500 may be part of the cartridge receptacle 118, for example, the cartridge interface 1218. When the vaporizer cartridge 1320 is coupled with the vaporizer body 110, for example, by being disposed at least partially inside the cartridge receptacle 118, the pod identifier contact 500 may be configured to form an electrical coupling between the PCBA 1203 (e.g., the controller 104) and one or more contacts 293 of the identification chip 174. FIGS. 5A-C show various configurations of the pod identifier contact 500 in which the material forming the pod identifier contact 500 is folded and/or crimped in different ways. For example, the example of the pod identifier contact 500 shown in FIG. 5A may include a bend (e.g., a 180° bend) at a location 407 of the material as well as other bends in other locations of the material.

Nevertheless, regardless of the configuration, it should be appreciated that the pod identifier contact 500 may be configured to exert a sufficient force against the contact 293 of the identification chip 174 to ensure that the contact between the contacts 293 of the identification chip 174 and the pod identifier contact 500 is adequate for a reading of the identification chip 174. For example, the pod identifier contact 500 may be preloaded such that the pod identifier contact 500 applies sufficient spring force against the contacts 293 of the identification chip 174. The pod identifier contact 500 may also be disposed at least partially within the sheath 1219 such that a portion 408 of the sheath 1219 may prevent the pod identifier contact 500 from over extending and another portion of the sheath 1219 may prevent the pod identifier contact 500 from contacting the shell 1220 (e.g., and causing a short circuit). Moreover, the dimensions of the pod identifier contact 500 may be configured to resist wear-and-tear from repeated bending of the pod identifier contact 500 as the vaporizer cartridge 1320 is inserted and removed from the vaporizer body 110.

FIG. 5D shows an example of the cartridge receptacle 118 which, as noted, may include the cartridge interface 1218 disposed inside the sheath 1219. As shown in FIG. 5D, the cartridge receptacle 118 includes multiple pod identifier contacts 500 including, for example, a first pod identifier contact 307A, a second pod identifier contact 307B, and a third pod identifier contact 307C, on a first side 404 of the cartridge receptacle 118. As FIG. 5D further shows, the cartridge receptacle may also include one or more receptacle contacts, for example, a first receptacle contact 125A and a second receptacle contact 125B, on a second side 402 of the cartridge receptacle 118. Whereas the first pod identifier contact 307A, the second pod identifier contact 307B, and the third pod identifier contact 307C are configured to form an electrical coupling with the contact 293 of the identification chip 174, the first receptacle contact 125A and the second receptacle contact 125B are configured to form an electrical coupling with the contacts 1326 of the heating element 1350 of the vaporizer cartridge 1320.

FIG. 5E depicts a top perspective view of the vaporizer body 110 including an example of the cartridge receptacle 118 consistent with implementations of the current subject matter. As shown in FIG. 5E, the cartridge receptacle 118 may be disposed at least partially within the sheath 1219. For example, in the example shown in FIG. 5E, the top rim of the cartridge receptacle 118 and the sheath 1219 may be substantially flush. The interior of the cartridge receptacle 118 may include one or more pod identifier contacts (e.g., the pod identifier contacts 307A, 307B, and 307C) and one or more receptacle contacts (e.g., the receptacle contacts 125A and 125B). Moreover, the vaporizer body 110 may also include one or more pod retention features 415, which may be disposed on an interior of the cartridge receptacle 118 and/or an exterior of the sheath 1219. Examples of the pod retention features 415 may include pins, clips, protrusions, detents, and/or the like. The pod retention features 415 may be configured to secure the cartridge 1320 within the cartridge receptacle 118 including by applying, against the cartridge 1320, a magnetic force, an adhesive force, a compressive force, a friction force, and/or the like.

In implementations where the pod retention features 415 are disposed inside the cartridge receptacle 118, the pod retention features 415 may be configured to form a mechanical coupling with, for example, at least a portion of the heating element 1350 (e.g., a portion of the one or more legs 506 disposed outside of the wick housing 1315) and/or a portion of the wick housing 1315 (e.g., the recesses in the wick housing 1315). Alternatively and/or additionally, in example implementations where the pod retention features 415 are disposed on an exterior of the sheath 1219, the pod retention features 415 may be configured to form a mechanical coupling with the housing of the vaporizer cartridge 1320. It should be appreciated that the pod retention features 415 may include various means of securing the cartridge 1320 within the cartridge receptacle 118. Moreover, the pod retention features 415 may be disposed at any suitable location in the vaporizer body 110.

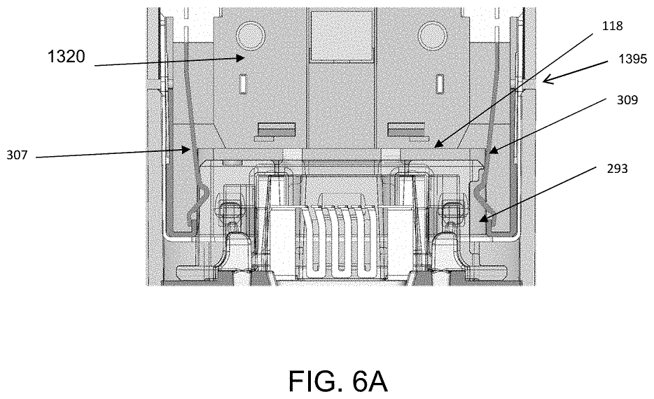

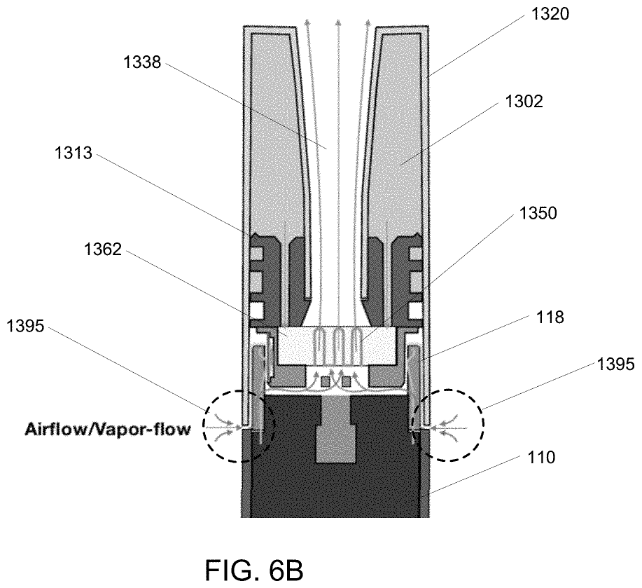

FIGS. 6A-B depict side cut-out views of the cartridge 1320 disposed within the cartridge receptacle 118 consistent with implementations of the current subject matter. As shown in FIG. 6A, the pod identifier contact 307 may be disposed on a first side the cartridge receptacle 118 and may be coupled to the identification chip 174 on the cartridge 1320. Additionally, the pod identifier contact 309 may be located on a second side of the cartridge receptacle 118 (opposite to the first side of the cartridge receptacle 118) and may be coupled to the cartridge 1320. FIG. 6A further shows the pod identifier contact 309 as being coupled to a contact 293 of the identification chip 174. It should be appreciated that the cartridge receptacle 118 may be sized to receive at least a portion of the cartridge 1320 including, for example, at least a portion of the wick housing 1315. For example, the cartridge receptacle 118 may be approximately 4.5 millimeters deep such that the wick housing 1315, which has a height of approximately 5 millimeters including a flange disposed at least partially around its upper perimeter, may be disposed partially within the cartridge receptacle 118 (e.g., up to the flange). The flange may remain outside of the cartridge receptacle 118 when the vaporizer cartridge 1320 is coupled with the vaporizer body 110 and may extend, at least partially, over a rim of the cartridge receptacle 118 and the sheath 1219.

As noted, one or more air inlets may be formed and/or maintained while the cartridge 1320 is coupled with the vaporizer body 110, for example, by being inserted into the cartridge receptacle 118. The one or more air inlets may be in fluid communication with the one or more slots in the wick housing 1315 such that air entering through the one or more air inlets may further enter the wick housing 1315 through the one or more slots to flow past and/or around the wicking element 1362. As noted, adequate airflow through the wick housing 1315 may be necessary to enable a proper and timely vaporization of the vaporizable material 1302 drawn into the wicking element 1362. In examples in which there are more than one air inlet, this plurality of air inlets may be disposed around the assembly including the cartridge 1320 and the vaporizer body 110. For example, two or more air inlets may be disposed on substantially opposite sides of the assembly including the vaporizer cartridge 1320 and the vaporizer body 110. It is also within the scope of the current subject matter to have more than one air inlet disposed on a same side of the assembly including the vaporizer cartridge 1320 and the vaporizer body 110 or to have air inlets on different, but not substantially opposite (e.g., adjacent), sides of such an assembly.

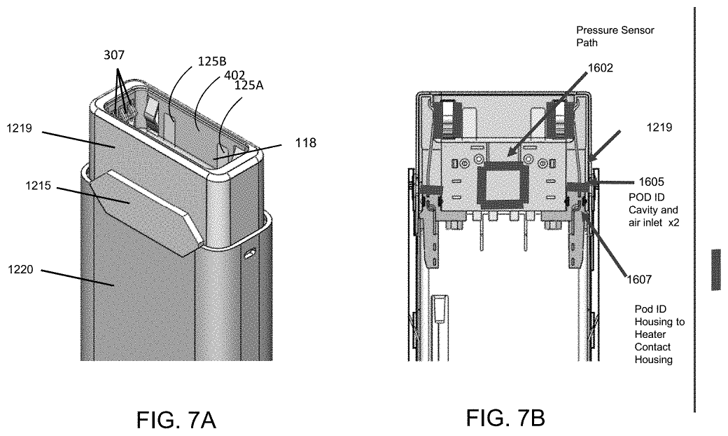

FIG. 7A depicts a perspective view of an assembled vaporizer body shell 1220 with the LED badge 1215 facing the front. As shown in FIG. 7A, the shell 1220 may include the cartridge receptacle 118 having a second side 402 with one or more pod retention features, the cartridge receptacle contacts 125A and 125B, and the pod identifier contacts 307. FIG. 7A further shows the shell 1220 as including at least one air inlet 1605 on the right-hand side of the shell 1220, but it should be appreciated that the shell 1220 may include additional air inlets disposed at different locations than shown. For example, in some implementations of the current subject matter, the air inlet 1605 may be positioned above a ridge 1387 in the shell 1220 that is formed by a first portion of the shell 1220 (including the sheath 1219) having a smaller cross-sectional dimension than a second portion of the shell 1220 beneath the sheath 1219 configured to accommodate at least a portion of the power source 112 (e.g., the battery 1212). The air inlet 1605 may be configured to allow ambient air to enter the cartridge 1320 and mix with the vapor generated in the atomizer 141. For example, the air inlet 1605 may be in fluid communication with the airflow passageway 1338 extending through the body of the cartridge 1320 such that ambient air may enter the airflow passageway 1338 via the air inlet 1605 when the cartridge 1320 is coupled with the shell 1220. The mixture of ambient air and the vapor generated in the atomizer 141 may be drawn through the air passageway 1338 for inhalation (e.g., into the user's mouth) through the mouthpiece 130.

Alternatively and/or additionally, the air inlet 1605 may be in fluid communication with the air vent 1318 disposed at one end of the overflow channel 1104 in the overflow volume 1344 of the collector 1313. As noted, air may travel into and out of the collector 1313 via the air vent 1318. For example, air bubbles trapped inside the collector 1313 may be released via the air vent 1318. Moreover, air may also enter the collector 1313 via the air vent 1318 in order to increase the pressure inside the reservoir 1340. Accordingly, it should be appreciated that the dimensions of the air inlet 1605, the shape of the air inlet 1605, and/or the position of the air inlet 1605 on the shell 1220 may be such that at least a portion of ambient air entering the air inlet 1605 may enter the collector 1313 via the air vent 1318 and that at least a portion of the air released from the collector 1313 from the air vent 1318 may exit via the air inlet 1605. The air inlet 1605 may be substantially round and have a diameter between 0.6 millimeters and 1.0 millimeters. For example, in some implementations of the current subject matter, the air inlet 1605 may be substantially round and have a diameter of approximately 0.8 millimeters. In some implementations of the current subject matter, the air vent 1318 may also be in fluid communication with the air passageway 1338. Accordingly, ambient air entering the air inlet 1605 may supply the collector 1313 (e.g., via the air vent 1318) and the air passageway 1338 (e.g., to create an inhalable aerosol).

FIG. 7B depicts a cross-sectional view of the vaporizer body shell 1220 consistent with implementations of the current subject matter. As shown in FIG. 7B, the shell 1220 may include a pressure sensor path 1602, the sheath 1219, the air inlet 1605 which may also include a pod identification cavity, and a pod ID housing 1607 which may include connections to the pod identifier contacts 307 or 309 and/or the receptacle contacts 125A and 125B. In some implementations of the current subject matter, the dimensions of the pressure sensor path 1602 may be configured to prevent an accumulation of the vaporizable material 1302, the presence of which in the pressure sensor path 1602 may create a hydrostatic head that skews the pressure readings made by the pressure sensor. Moreover, the pressure sensor may be secured to the PCBA 1203 at a location where the likelihood of other components of the vaporizer body 110 coming into contact with the pressure sensor is minimal, thereby avoiding inadvertent strain against the pressure sensor that can skew the pressure readings made by the pressure sensor.

In some implementations of the current subject matter, the vaporizer body 110 may include circuitry for charging the vaporizer device 100, for example, the power source 112. For example, charging circuitry included in the vaporizer body 110 may be configured to form an inductive coupling with an external charger device. Energy may be transferred from the charger device to the vaporizer device 100, for example, the power source 112, through the inductive coupling. For instance, an alternating current running through a first induction coil at the charger device may create a magnetic field whose strength fluctuates in response to the changing magnitude of the alternating current. This fluctuating magnetic field may generate an electromotive force that induces a corresponding alternating current in a second induction coil included in the vaporizer body 110. Moreover, the alternating current in the second induction coil may be converted to a direct current, for example, with a rectifier, and used to charge the power source 112 at the vaporizer device 100.

In some implementations of the current subject matter, the vaporizer body 110 may include a retention feature configured to interact with a corresponding retention feature at the external charger device in order to secure the vaporizer body 110 to the charger device. The retention feature may be configured to align and/or maintain the vaporizer body 110 in a correct position and/or orientation relative to the charger device for forming the inductive coupling with the external charger device. To enable charging of the vaporizer device 100 regardless of whether the vaporizer cartridge 1320 is coupled with the vaporizer body 110, the retention feature may be configured to secure the vaporizer body 110 to the external charger device whether the vaporizer body 110 is coupled with the vaporizer cartridge 1320 or decoupled from the vaporizer cartridge 1320. Moreover, to enable charging of the vaporizer device 100 when one or more specific surfaces of the vaporizer body 110 is coupled with the charger device, the retention feature may be configured to align the charger device towards those surfaces of the vaporizer body 110. For instance, the retention feature may be configured such that the charger device and the vaporizer device 100 are coupled one or more faces (e.g., front face and/or back face) of the vaporizer body 110. Alternatively and/or additionally, the retention feature may be configured to secure the vaporizer body 110 to the charger device on any surface (e.g., front face, back face, left side, right side, and/or the like) of the vaporizer body 110.

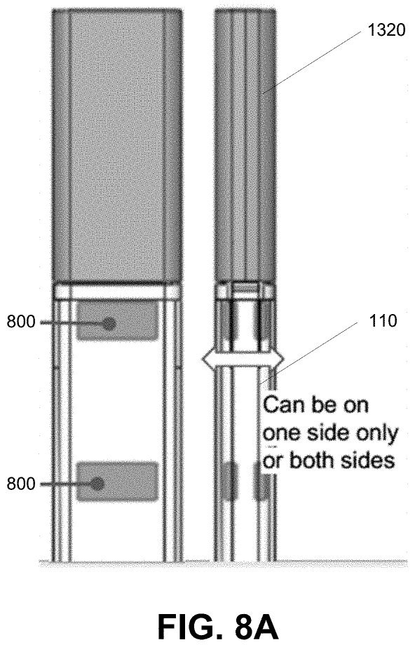

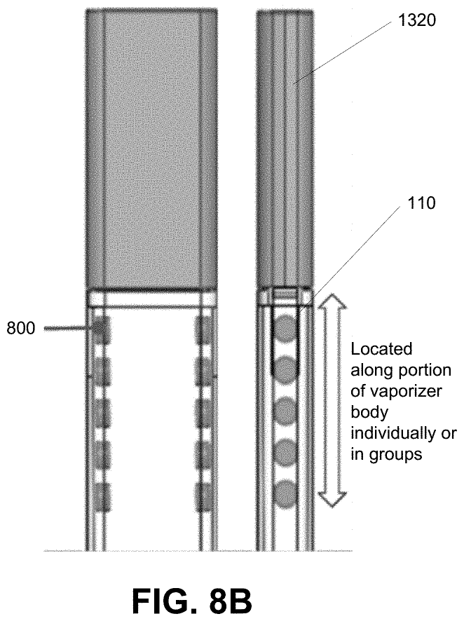

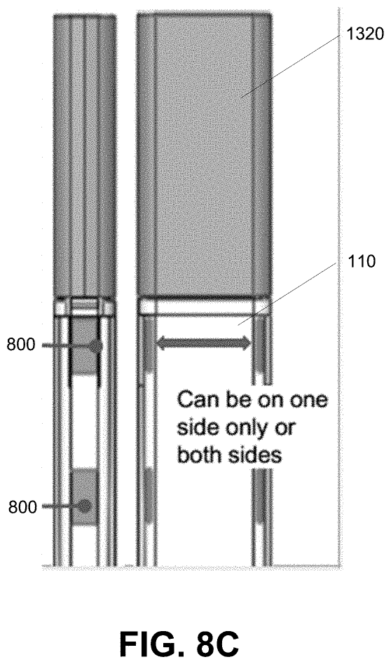

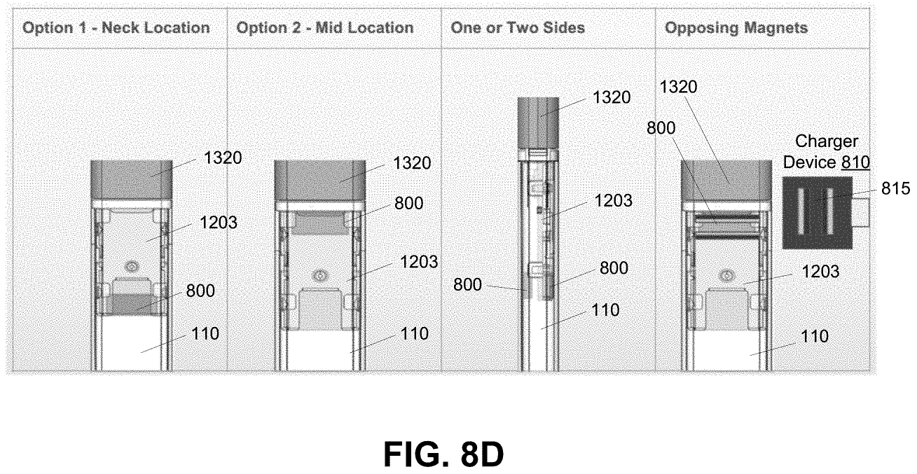

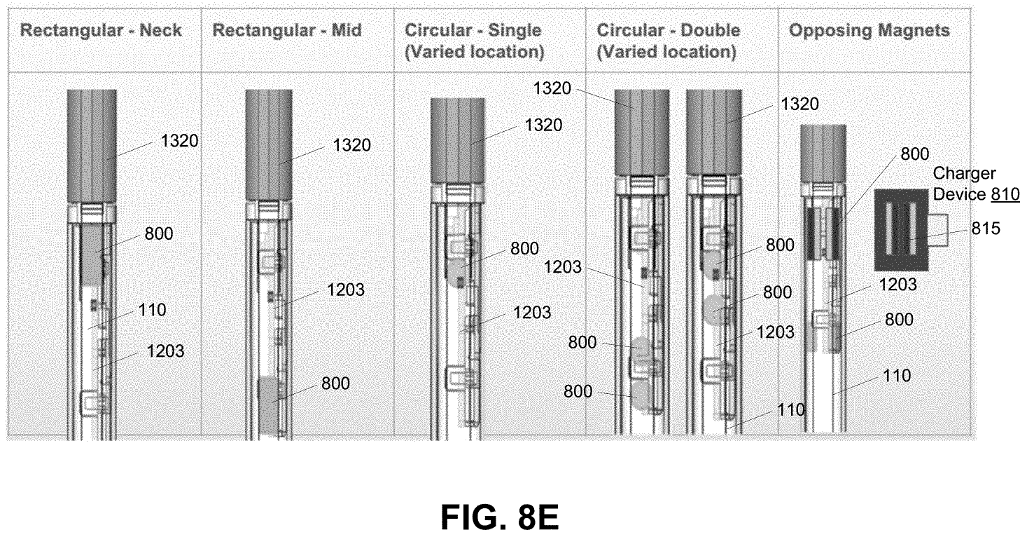

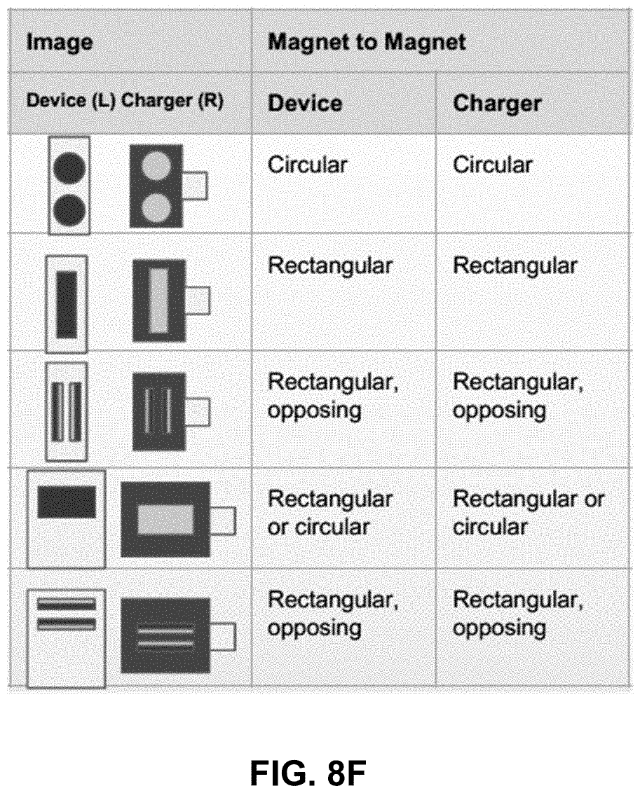

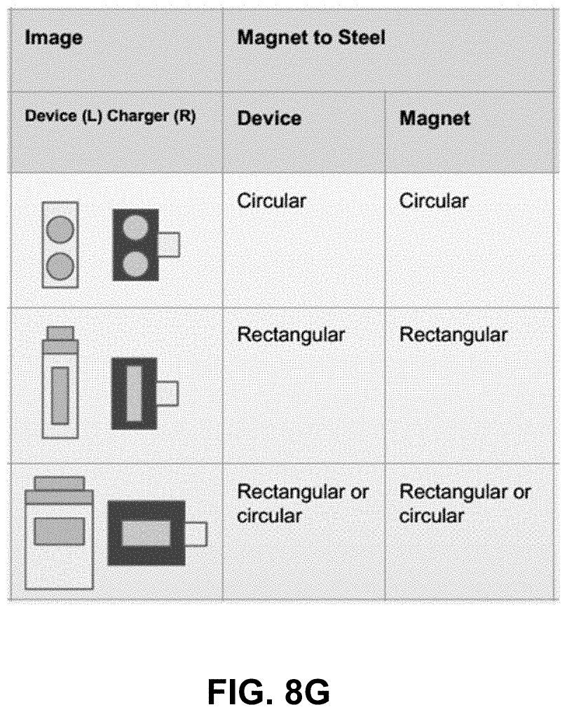

As shown in FIGS. 8A-G, the retention feature at the vaporizer device 100 as well as the corresponding retention feature at the charger device may be configured in a variety of mechanisms (e.g., magnetic coupling, mechanical coupling, and/or the like), shapes (e.g., circular, rectangular, and/or the like), and/or materials (e.g., magnet-to-magnet, magnet-to-metal, and/or the like). Moreover, the placement of the retention feature may also vary, particularly in the vaporizer body 110 of the vaporizer device 100. For example, the retention feature at the vaporizer device 100 may be placed at one or more locations along the face of the vaporizer body 110 and/or the side of the vaporizer body 110. It should be appreciated that the placement of the retention feature at the vaporizer body 110 may at least partially determine the location at which the charger device couples with the vaporizer device 100.

To further illustrate, FIGS. 8A-C depicts an example of a retention feature 800 having different placement within the vaporizer body 110 consistent with implementations of the current subject matter. For example, in FIG. 8A, one or more of the retention feature 800 are placed along the front face and/or the back face of the vaporizer body 110. In FIGS. 8B-C, one or more of the retention feature 800 are placed along one or more sides of the vaporizer body 110, either individually or in groups.

FIGS. 8D-E depicts the different placement of the retention feature 800 along one or more faces and/or sides of the vaporizer body 110. For example, FIG. 8D shows the retention feature 800 as being placed near a top of the vaporizer body 110, proximate to the cartridge receptacle 118. Alternatively and/or additionally, FIG. 8D shows that the retention feature 800 may be placed lower along the vaporizer body 110, for example, towards a center of the vaporizer body 110. In some implementations of the current subject matter, the retention feature 800 may include a collection of opposing magnets configured to interact with a corresponding collection of opposing magnets forming a retention feature 815 at a charger device 810. As shown in FIG. 8D, the retention feature 800 may be disposed on (or near) the PCBA 1203 along one or more faces of the vaporizer body 110. For instance, the retention feature 800 may be placed along the front face of the vaporizer body 110 and/or the back face of the vaporizer body 110.

In FIG. 8E, the retention feature 800 is placed at various locations along one or more sides of the vaporizer body 110. As shown in FIG. 8E, one or more of the retention feature 800 may be placed at one or more locations (e.g., near the top of the vaporizer body 110, towards the center of the vaporizer body 110, and/or the like) along one or more sides of the vaporizer body 110. The retention feature 800 may include one or more collections of opposing magnets configured to interact with one or more corresponding collections of opposing magnets forming the retention feature 815 of the charger device 810. Moreover, the retention feature 800 may vary in shape including, for example, being circular, rectangular, and/or the like.

FIG. 8F depicts various examples of magnet-to-magnet retention features consistent with implementations of the current subject matter. As shown in FIG. 8F, the retention feature 800 at the vaporizer body 110 and the retention feature 815 at the charger device 810 may be implemented using magnets including, for example, magnets having different shapes. For example, the retention feature 800 at the vaporizer body 110 may be a rectangular (or circular) magnet while the retention feature 815 at the charger device 810 may be a corresponding rectangular (or circular) magnet. Alternatively and/or additionally, the retention feature 800 at the vaporizer body 110 may be a collection of rectangular opposing magnets and the retention feature 815 at the charger device 810 may be a corresponding collection of rectangular opposing magnets.

FIG. 8G depicts various examples of magnet-to-metal retention features consistent with implementations of the current subject matter. In the examples shown in FIG. 8G, the retention feature 800 at the vaporizer body 110 may be implemented using magnets while the retention feature 815 at the charger device 810 may be implemented using one or more blocks of ferrous metal (e.g., steel and/or the like). Alternatively, the retention feature 800 at the vaporizer body 110 may be implemented using one or more blocks of ferrous metal while the retention feature 815 at the charger device 810 may be implemented using magnets. As shown in FIG. 8G, the magnet-to-metal retention features may be implemented in a variety of shapes including, for example, circular, rectangular, and/or the like.

Referring again to FIG. 4, the vaporizer body 110 may include a number of components including, for example, the shell 1220, the sheath 1219, the battery 1212, the printed circuit board assembly (PCBA) 1203, the antenna 1217, the skeleton 1211, the charge badge 1213, the cartridge interface 1218, the endcap 1201, and the LED badge 1215. In some implementations of the current subject matter, the assembly of the vaporizer body 110 may include securing the battery 1212, the PCBA 1203, and the antenna 1217 to the skeleton 1211. The sheath 1219 may be integral to the shell 1220 such that the sheath 1219 and the shell 1220 may be formed as a solitary unit. Alternatively, the sheath 1219 may be coupled to the shell 1220 (e.g., by adhesives, friction fit, welding and/or the like), in which case the cartridge interface 1218 may be further secured to the skeleton 1211 before the assembly including the skeleton 1211, the cartridge interface 1218, the battery 1212, and the PCBA 1203 are inserted into the shell 1220. Alternatively, the sheath 1219 and the cartridge interface 1218 may form a first assembly that is secured to the shell 1220 while the skeleton 1211, the PCBA 1203, and the battery 1212 may form a second assembly that is inserted into the shell 1220. An open end of the shell 1220 distal to the cartridge receptacle 118 may be sealed with the endcap 1201.

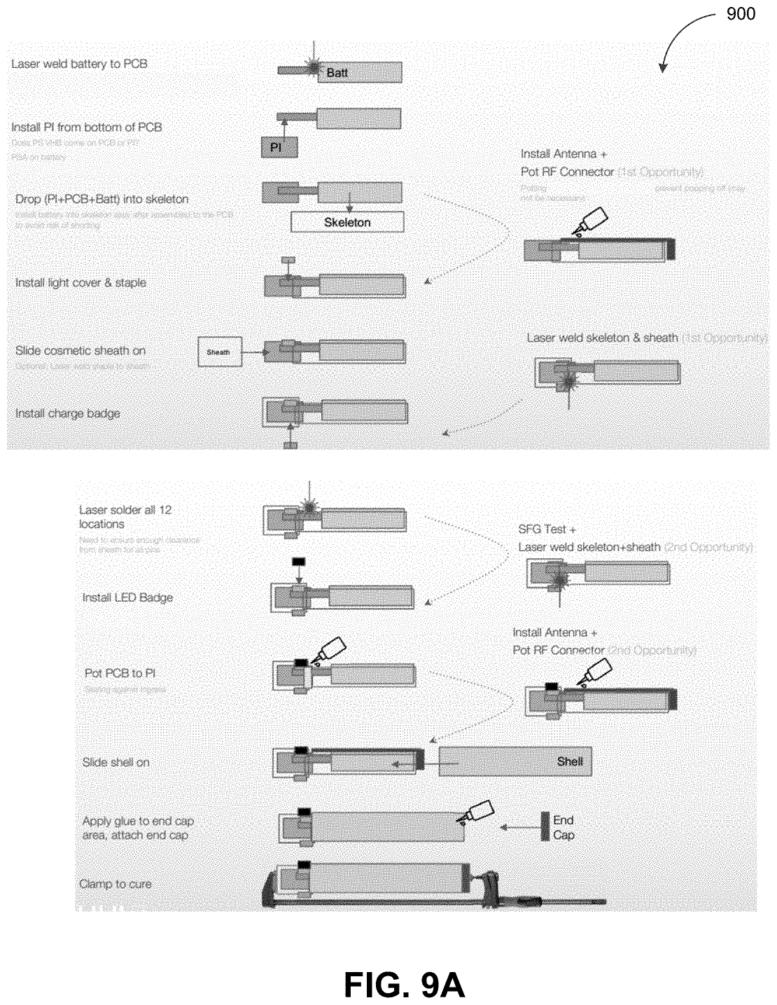

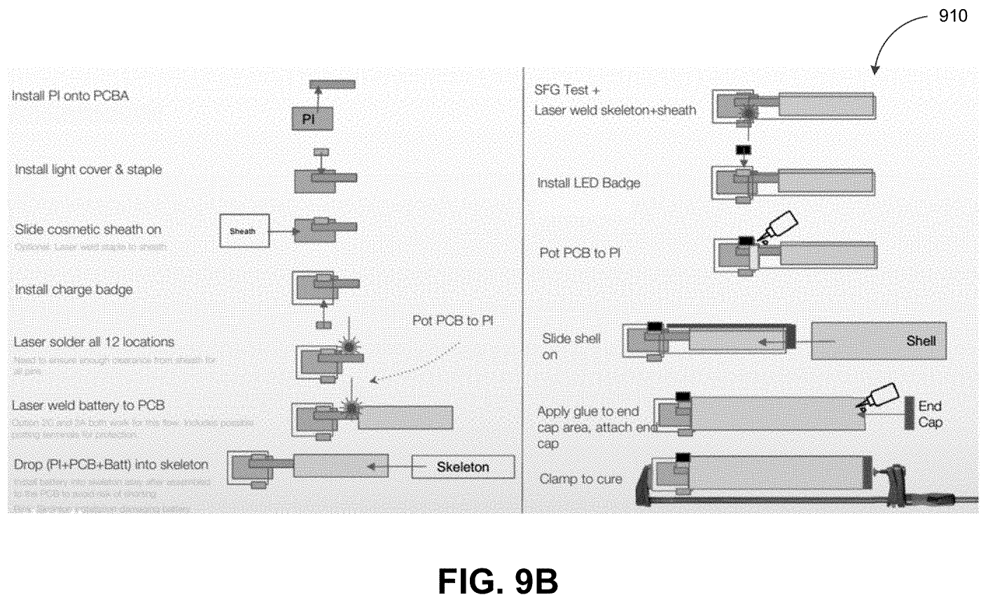

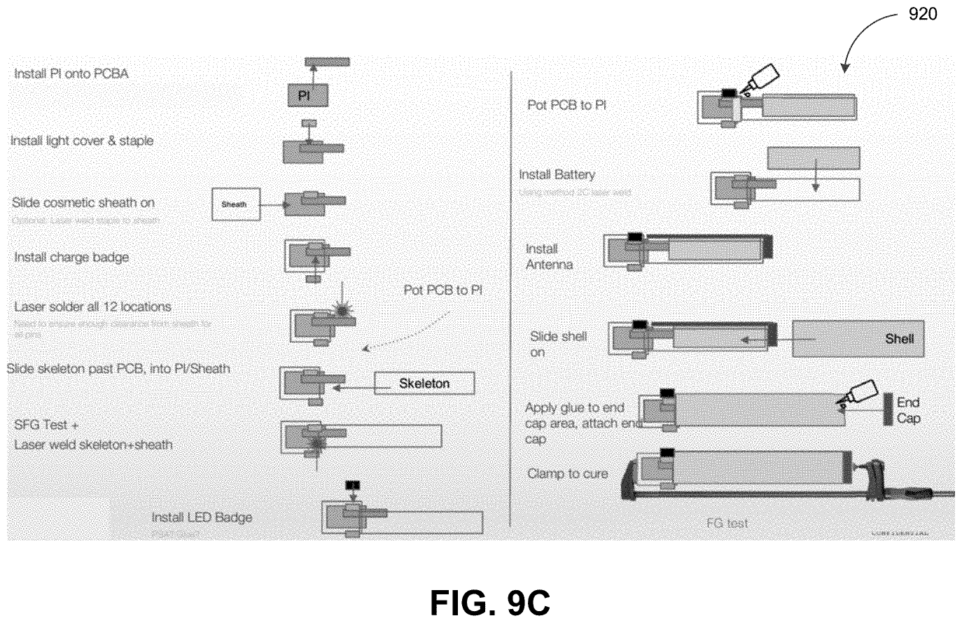

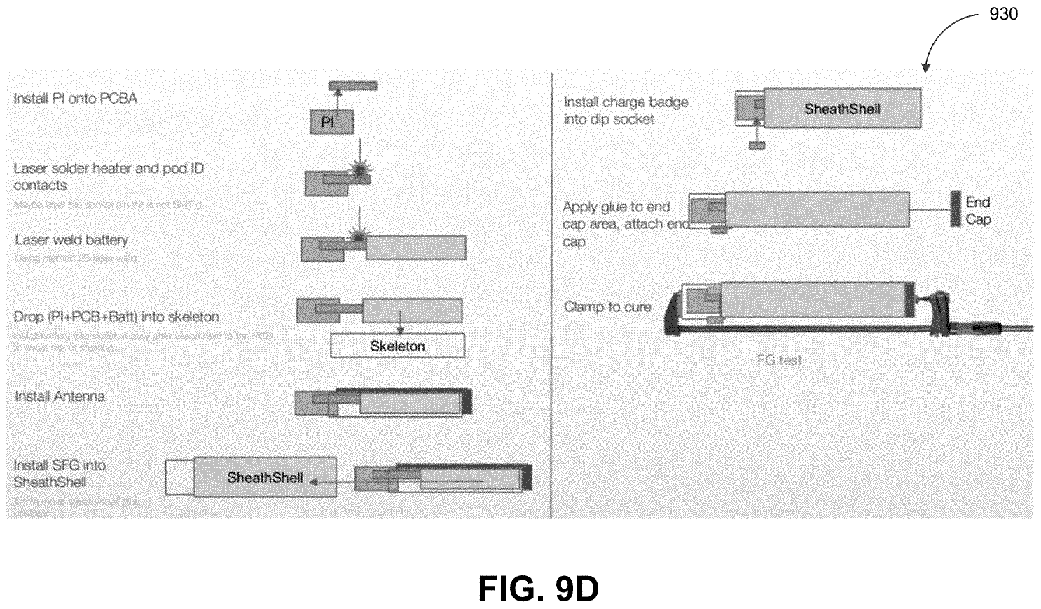

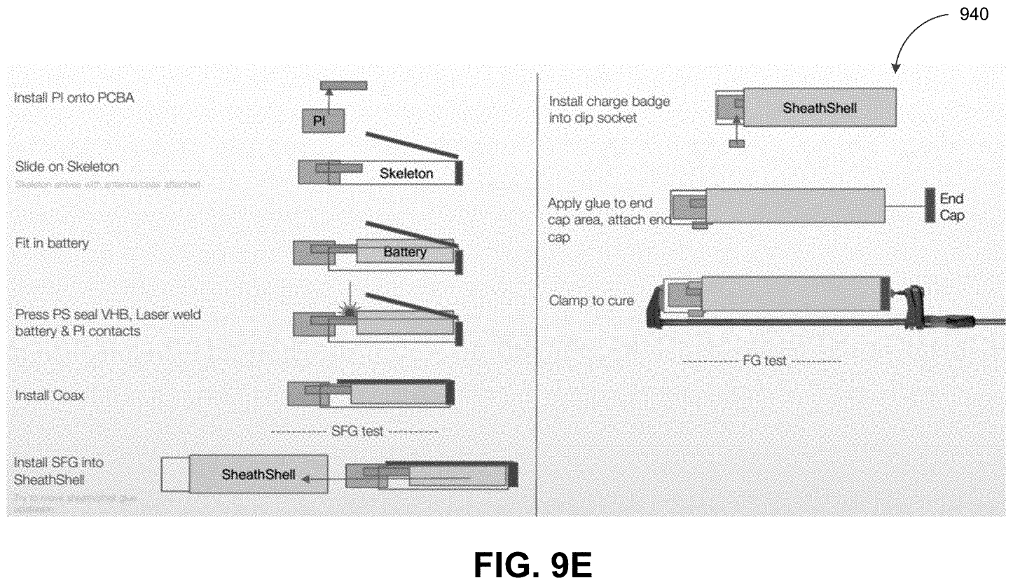

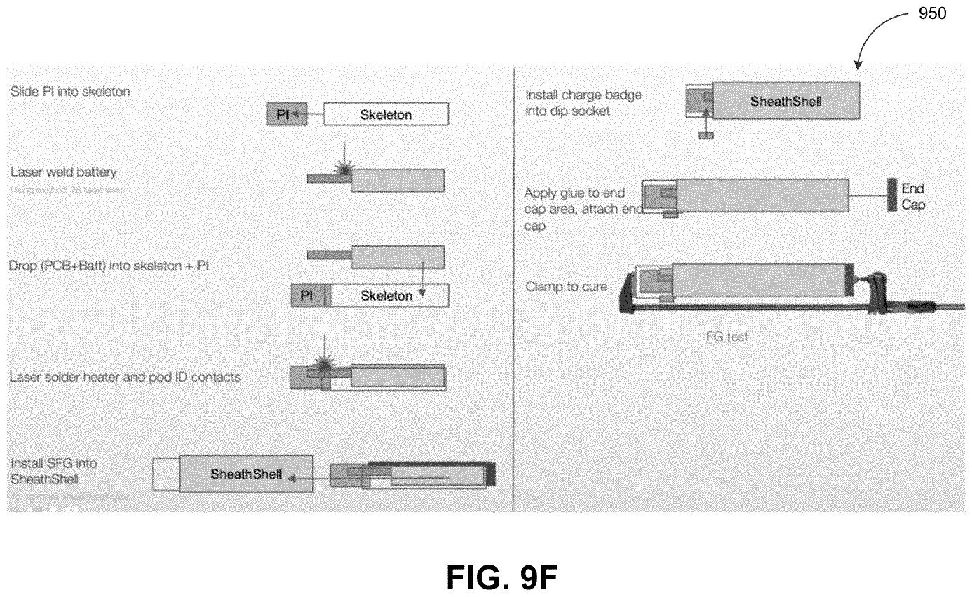

To further illustrate, FIGS. 9A-F depict various examples of processes for assembling the vaporizer body 110 consistent with implementations of the current subject matter. For example, FIG. 9A depicts an example of a process 900 for assembling the vaporizer body 110, which may include securing (e.g., by laser welding and/or another technique) the battery 1212 to the PCBA 1203 before installing the cartridge interface 1218 onto the PCBA 1203. The antenna 1217 may be attached to the skeleton 1211 at this point or later on. A cover for light emitting diodes (LEDs) may be installed onto the cartridge interface 1218 before the sheath 1219 is slid over the cartridge interface 1218. In the example of the process 900 shown in FIG. 9A, the sheath 1219 may be secured to the skeleton 1211 by laser welding (or another technique). The charge badge 1213 may be affixed to one side of the sheath 1219, for example, that is opposite of the light emitting diodes. Moreover, additional soldering and some testing (e.g., semi-finished-good (SFG) testing and/or the like) may be performed before the LED badge 1215 is installed onto the sheath 1219. If the antenna 1217 was not installed earlier, the antenna 1217 may be installed at this point before the assembly including the skeleton 1211, the sheath 1219, the cartridge interface 1218, the battery 1212, the PCBA 1203, the charge badge 1213, and the LED badge 1215 is inserted into the shell 1220. The endcap 1201 may be attached to an inferior end of the shell 1220, for example, by adhesives (or another mechanism) and clamped to cure.

FIG. 9B depicts another example of a process 910 for assembling the vaporizer body 110 consistent with implementations of the current subject matter. As shown in FIG. 9B, the process 910 may include first installing the cartridge interface 1218 onto the PCBA 1203 followed by the cover for the light emitting diodes (LEDs) on the cartridge interface 1218 before the sheath 1219 is slid over the assembly including the cartridge interface 1218 and the PCBA 1203. The charge badge 1213 is affixed to one side of the sheath 1219, for example, opposite of the light emitting diodes before soldering is performed and the battery 1212 is attached to the PCBA 1203 (e.g., by laser welding and/or a different technique). The resulting assembly including the PCBA 1203, the battery 1212, the cartridge interface 1218 covered with the sheath 1219, and the charge badge 1215 may be coupled with the skeleton 1211. This assembly including the skeleton 1211 may be subject to additional welding (e.g., laser welding and/or the like) to secure the skeleton 1211 to the sheath 1219 as well as testing (e.g., semi-finished-good (SFG) testing and/or the like)). The LED badge 1215 may be installed onto the sheath 1219 at this point and the antenna 1217 may be installed before the entire assembly including the skeleton 1211, the cartridge interface 1218 covered with the sheath 1219, the charge badge 1213, the battery 1212, the PCBA 1203, the antenna 1217, the LED badges 1215, and the charge badge 1213 is inserted into the shell 1220. The endcap 1201 may be attached to an inferior end of the shell 1220, for example, by adhesives (or another mechanism) and clamped to cure.

FIG. 9C depicts another example of a process 920 for assembling the vaporizer body 110 consistent with implementations of the current subject matter. In the example of the process 920 shown in FIG. 9C, the battery 1212 may be installed in the skeleton 1211 after the skeleton 1211 has been secured to the assembly including the sheath 1219, the cartridge interface 1218, the PCBA 1203, the LED badge 1213, and the charge badge 1215. This is in contrast to the process 910 shown in FIG. 9B in which the battery 1212 is first attached to the assembly including the sheath 1219, the cartridge interface 1218, the PCBA 1203, and the charge badge 1213 before being coupled with the skeleton 1211.

FIG. 9D depicts another example of a process 930 for assembling the vaporizer body 110 consistent with implementations of the current subject matter. Referring to FIG. 9D, the process 930 may include installing the cartridge interface 1218 onto the PCBA 1203 before attaching the one or more of the receptacle contacts 125 and the pod identifier contacts 307, for example, by laser soldering and/or the like. The battery 1212 may be attached to the assembly including the cartridge interface 1218 and the PCBA 1203 before being coupled with the skeleton 1211 and installing the antenna 1217. The resulting assembly including the cartridge interface 1218, the PCBA 1203, the battery 1212, the skeleton 1211, and the antenna 1217 may be inserted into another assembling including the sheath 1219 and the shell 1220. Here, it should be appreciated that the sheath 1219 may be attached to the shell 1220 (e.g., by adhesives, friction fit, welding and/or the like) or the sheath 1219 and the shell 1220 may be formed as a solitary unit. The charge badge 1213 and the LED badge 1215 may be installed. Moreover, the endcap 1201 may be attached to an inferior end of the shell 1220, for example, by adhesives (or another mechanism) and clamped to cure.

FIG. 9E depicts another example of a process 940 for assembling the vaporizer body 110 consistent with implementations of the current subject matter. Referring to FIG. 9E, the assembly of the vaporizer body 110 may include installing the cartridge interface 1218 onto the PCBA 1203 to form a first assembly that is then coupled with a second assembly that includes the skeleton 1211 coupled with the antenna 1217. The battery 1212 is then disposed within the skeleton 1211 and secured to the PCBA 1203 (e.g., using laser welding and/or another technique). The antenna 1217 is then installed before the resulting assembling is subject to testing such as a semi-finished-goods (SFG) testing and/or the like). Thereafter, the assembly including the cartridge interface 1218, the PCBA 1203, the battery 1212, the skeleton 1211, and the antenna 1217 may be inserted into another assembling including the sheath 1219 and the shell 1220. The charge badge 1213 and the LED badge 1215 may be installed before (or after) the endcap 1201 is attached to an inferior end of the shell 1220, for example, by adhesives (or another mechanism) and clamped to cure.

FIG. 9F depicts another example of a process 950 for assembling the vaporizer body 110 consistent with implementations of the current subject matter. In the example of the process 950 shown in FIG. 9F, the cartridge interface 1218 may be attached to the skeleton 1211 to form a first assembly while the battery 1212 and the PCBA 1203 may be coupled to form a second assembly. The first assembly including the cartridge interface 1218 and the skeleton 1211 may then be coupled with the second assembly including the battery 1212 and the PCBA 1203, for example, by inserting the second assembly into the skeleton 1211 of the first assembly. One or more of the receptacle contacts 125 and the pod identifier contacts 307 may be attached to the cartridge interface 1218, for example, by laser soldering and/or the like. The resulting assembly including the cartridge interface 1218, the PCBA 1203, the battery 1212, the skeleton 1211, and the antenna 1217 may be inserted into another assembling including the sheath 1219 and the shell 1220. Thereafter, the charge badge 1213 and the LED badge 1215 may be installed before (or after) the endcap 1201 is attached to an inferior end of the shell 1220, for example, by adhesives (or another mechanism) and clamped to cure.

### Terminology

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the teachings herein. For example, the order in which various described method steps are performed may often be changed in alternative embodiments, and in other alternative embodiments, one or more method steps may be skipped altogether. Optional features of various device and system embodiments may be included in some embodiments and not in others. Therefore, the foregoing description is provided primarily for exemplary purposes and should not be interpreted to limit the scope of the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A vaporizer device, comprising:
a shell;
a cartridge receptacle formed from a cartridge interface disposed at least partially inside a sheath, the cartridge interface configured to provide a plurality of electrical couplings with a vaporizer cartridge when the vaporizer cartridge is disposed at least partially inside the cartridge receptacle, the plurality of electrical couplings including a first electrical coupling with a heating element of the vaporizer cartridge, and the plurality of electrical couplings further including a second electrical coupling with a cartridge identification chip of the vaporizer cartridge; and
a skeleton coupled with the cartridge interface, the skeleton configured to secure the cartridge interface inside the shell.

2. The vaporizer device of claim 1, further comprising:
a battery; and
a printed circuit board assembly comprising a controller of the vaporizer device, the printed circuit board assembly being coupled to the battery and the cartridge interface to form a first assembly, the first assembly being coupled to the skeleton to form a second assembly that is disposed inside the shell.

3. The vaporizer device of claim 2, wherein the second assembly further includes an antenna.

4. The vaporizer device of claim 3, wherein the shell is formed from a first material, wherein the vaporizer device further includes an endcap formed from a second material that is more penetrable to radio waves from the antenna than the first material, and wherein the endcap is configured to seal an open end of the shell opposite to the cartridge receptacle.

5. The vaporizer device of claim 4, wherein the shell includes one or more insets formed from the second material and/or a third material that are more penetrable to radio waves from the antenna than the first material.

6. The vaporizer device of claim 1, wherein the cartridge interface includes a set of receptacle contacts configured to form the first electrical coupling with a set of heater contacts of the heating element of the vaporizer cartridge.

7. The vaporizer device of claim 6, wherein the set of receptacle contacts include two pairs of electrical contacts disposed at opposite sides of the cartridge receptacle.

8. The vaporizer device of claim 6, wherein the cartridge interface further includes a set of cartridge identifier contacts configured to form the second electrical coupling with a corresponding set of cartridge identifier contacts at the cartridge identification chip of the vaporizer device.

9. The vaporizer device of claim 8, wherein the set of cartridge identifier contacts includes a first set of three electrical contacts disposed at one side of the cartridge receptacle and a second set of three electrical contacts disposed at an opposite side of the cartridge receptacle.

10. The vaporizer device of claim 8, wherein the set of cartridge identifier contacts includes at least one electrical contact that is preloaded to exert a force against a corresponding electrical contact at the cartridge identification chip.

11. The vaporizer device of claim of claim 10, wherein the sheath is configured to prevent an overextension of the at least one electrical contact, and wherein the sheath is further configured to prevent contact between the at least one electrical contact and the shell of the vaporizer device.

12. The vaporizer device of claim 1, wherein the cartridge receptacle is configured to receive the vaporizer cartridge in a first rotational orientation and a second rotational orientation, and wherein the cartridge interface is configured to provide the plurality of electrical couplings with the vaporizer cartridge whether the vaporizer cartridge is inserted the first rotational orientation or the second rotational orientation.

13. The vaporizer device of claim 1, wherein the sheath and the shell are formed as a solitary unit.

14. The vaporizer device of claim 1, wherein the sheath is coupled to the shell by one or more of an adhesive, a friction fit, and/or a welding.

15. The vaporizer device of claim 1, wherein the cartridge interface is further configured to form, with the vaporizer cartridge, a mechanical coupling configured to retain the vaporizer cartridge inside the cartridge receptacle.

16. The vaporizer device of claim 1, further comprising:
a first retention feature configured to couple the vaporizer device to a charger device, the first retention feature configured to form a magnetic coupling with a second retention feature at the charger device, the magnetic coupling aligning and maintaining the vaporizer device in one or more position and/or orientation relative to the charger device.

17. The vaporizer device of claim 16, wherein the first retention feature and the second retention feature each comprise one or more magnets.

18. The vaporizer device of claim 16, wherein one of the first retention feature and the second retention feature comprises one or more magnets, and wherein the other one of the first retention feature and the second retention feature comprises one or more blocks of ferrous metal.

19. The vaporizer device of claim 1, wherein the skeleton includes one or more detents for securing, to an interior of the shell, the skeleton coupled with the cartridge interface.

20. The vaporizer device of claim 1, wherein the cartridge receptacle is configured to receive at least a portion of a wick housing containing a wicking element of the vaporizer cartridge, and the first electrical coupling being formed by at least contacting a contact portion of the heating element disposed at least partially outside of the wick housing while a heating portion of the heating element is disposed at least partially inside the wick housing.
